(19) United States
(12) Patent Application Publication
(10) Pub. No.: US 2015/0143245 A1
(43) Pub. Date: May 21, 2015

(54) TRACKING CONTENT THROUGH SERIAL PRESENTATION

(71) Applicant: SPRITZ TECHNOLOGY, INC., Stoneham, MA (US)

(72) Inventors: Francis Abbott WALDMAN, Stoneham, MA (US); Maik Steffen MAURER, Ismaning (DE); James Chad LOCKE, Salt Lake City, UT (US)

(73) Assignee: SPRITZ TECHNOLOGY, INC., Stoneham, MA (US)

(21) Appl. No.: 14/523,805

(22) Filed: Oct. 24, 2014

Related U.S. Application Data
(60) Provisional application No. 61/895,339, filed on Oct. 24, 2013.

(51) Int. Cl. H04L 12/24; G06F 17/27

(52) U.S. Cl. CPC H04L 41/22; G06F 17/271
USPC 715/736

(57) ABSTRACT

Computer-implemented methods, computer program products, and systems are disclosed for tracking content use, the content including textual content that is displayable using RSVP. A particular embodiment identifies content, including textual content, to be displayed using RSVP on an electronic device to a user, displays that content to the user using RSVP, and generates content tracking information by tracking information items of the textual content that are displayed using RSVP. In some embodiments, analysis of what information items have been presented to the user and when is used in combination with analysis of information content items in candidate content items to affect rankings of those candidate content items to be potentially presented to a user in response to a search request or other user interface action received from a user device.

### CROSS REFERENCE TO RELATED APPLICATIONS

This application claims the benefit of U.S. Provisional Application Ser. No. 61/885,339 filed Oct. 24, 2013. The subject matter of this application is also related to the subject matter of the following co-pending U.S. patent applications: U.S. application Ser. No. 13/547,982 filed on Jul. 12, 2012; U.S. application Ser. No. 13/730,163 filed on Dec. 28, 2012; U.S. application Ser. No. 13/919,848 filed Jun. 17, 2013; and U.S. application Ser. No. 14/047,975 filed on Oct. 7, 2013. The disclosures of all five of these applications are hereby incorporated by reference in their entirety.

### BACKGROUND

Electronic devices and systems are frequently relied upon to provide information to users. Content providers and distributors naturally desire to track usage of that content. Content providers and advertisers rely on tracking content use and advertisement use on the Internet to determine appropriate content and to identify relevant content and ads to present to particular users.

Presently available systems for tracking content usage typically determine whether a particular piece of content was accessed by a user by, for example, tracking page hits for freely available content and tracking purchases of and/or logins to restricted access content. Also, techniques have been proposed for determining and tracking certain types of interactions with webpage content such as scrolling (see, for example, “Advanced Content Tracking with Google Analytics: part 1” posted Feb. 21, 2012 at http://cutroni.com/blog/2012/02/21/advanced-content-tracking-with-google-analytics-part-1/#wrap).

### SUMMARY

Although existing content tracking schemes can determine whether content was accessed, systems and methods are needed to better determine whether content, particularly text content, was in fact consumed, i.e., read by the user. Also, there is a need to better track partial consumption to determine, for example, how much text in a given piece of content was read. Also, by identifying particular words or phrases in a given piece of content that are key to conveying information (hereinafter referred to as “information items”), it is possible to track and aggregate the knowledge that a user obtains by consuming information items. Furthermore, tracking the consumption of information items for a user can enable content providers and advertisers to improve the relevance of content that is presented to this user or other users, including search results, news articles, and sponsored content such as advertisements.

Communications devices, including PCs, smartphones, tablets, e-readers, wearables (e.g. smart watches) etc. continue to grow in popularity, and have become an integral part of both personal and business communications. As a result, users continue to spend more time using their communications devices during the course of a day reading e-mails, reading web sites, reading news articles with mobile applications, sending short message service (SMS) messages, etc.

Rapid serial visual presentation (RSVP) is a method of displaying textual content in which each word of the textual content is displayed in sequential order, one at a time, at a certain display rate, at a fixed location on a display. RSVP was first introduced in the 1970s as a technique for presenting text one word at a time in a display. Many references since then have provided information on the use of RSVP in a variety of applications. Commercially available products based on RSVP include “Zap Reader” (www.zapreader.com/reader) and “Spreeder” (www.spreeder.com). Some prior methods exist for improving the effectiveness of an RSVP by varying the display time of a word in the display based on word length and word type (see, U.S. Pat. No. 6,130,968 to McIan et al. (“McIan”)) and based on word frequency (see WO/37256 by Goldstein et al. (“Goldstein 2002”)).

Isolated efforts have also been made to apply RSVP to particular applications (e.g., email applications) in mobile communications devices (see, US 2011/0115819 to Hanson). However, the challenges and opportunities for integrating RSVP into user interfaces for increasing the density of displayable content remain largely unexplored. Moreover, despite the increased need for more accurately tracking content consumption, RSVP has not yet been exploited for that purpose.

In accordance with embodiments of the present invention, computer-implemented methods, computer program products, and systems are provided for provisioning content and tracking content use, the content including textual content that is displayable using RSVP. A particular embodiment identifies content, including textual content, to be displayed using RSVP on an electronic device to a user, displays that content to the user using RSVP, and generates content tracking information by tracking information items of the textual content that are displayed using RSVP. In some embodiments, a user session identifier is stored and related to a content identifier in an electronic database.

In some embodiments, other variables are tracked and stored and are associated with the content identifier including, for example, variables that track an information item identifier, an equivalent information item identifier, an associated topic identifier, and an associated position of an information item in terms of the number of words from the start of the content to that information item. In some embodiments, tracked textual content is provided in the context of tracked content including various mixed media types including, for example, maps, images, video, audio, and/or augmented reality.

In some embodiments, tracked RSVP data is aggregated by user, user category, topic, and information item. In some embodiments, RSVP aggregated data analytics (including totals, averages, percentages, ratios, densities, up-to-dateness, and/or rates of change corresponding to such data) corresponding to digital media items are utilized to determine the relevance of those items to a user or enrich search ranking results related to those items. In a particular aspect of such an embodiment, RSVP aggregated data analytics for a user (including information item totals, total number of words, and number of information item appearances) are used to calculate a rating for adjusting the order of display of digital media items. Furthermore, in some embodiments, the RSVP aggregated data analytics for a user may be stored only on that user's device in order to maintain the privacy of the user.

### BRIEF DESCRIPTION OF THE DRAWINGS

FIG. 1 is a diagram of a computer system in the context of a computer network in accordance with one embodiment of the present invention.

FIG. 2a is a block diagram of exemplary software modules included in the computer program product loaded on the user device of FIG. 1 in accordance with one embodiment of the present invention.

FIG. 2b illustrates a configuration of server computer 101 of FIG. 1, according to an embodiment of the present invention.

FIG. 3 is a block diagram of exemplary software modules included in the RSVP library of FIG. 2a in accordance with one embodiment of the present invention.

FIGS. 4a and 4b illustrate process flows implemented by a computer system in accordance with an embodiment of the present invention for tracking the creation and viewing of RSVP content integrated in media to capture data that can be used for analytics.

FIG. 5 illustrates process flows implemented by a computer system in accordance with an embodiment of the present invention for tracking and aggregating usage data for RSVP contents for each user.

FIG. 6 illustrates process flows implemented by a computer system in accordance with an embodiment of the present invention for generating rating data for RSVP contents to improve relevance of content and content listings presented to a user.

### DETAILED DESCRIPTION

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, the present disclosure is not intended to be limited to the embodiments shown, but is to be accorded the widest scope consistent with the principles and features disclosed herein.

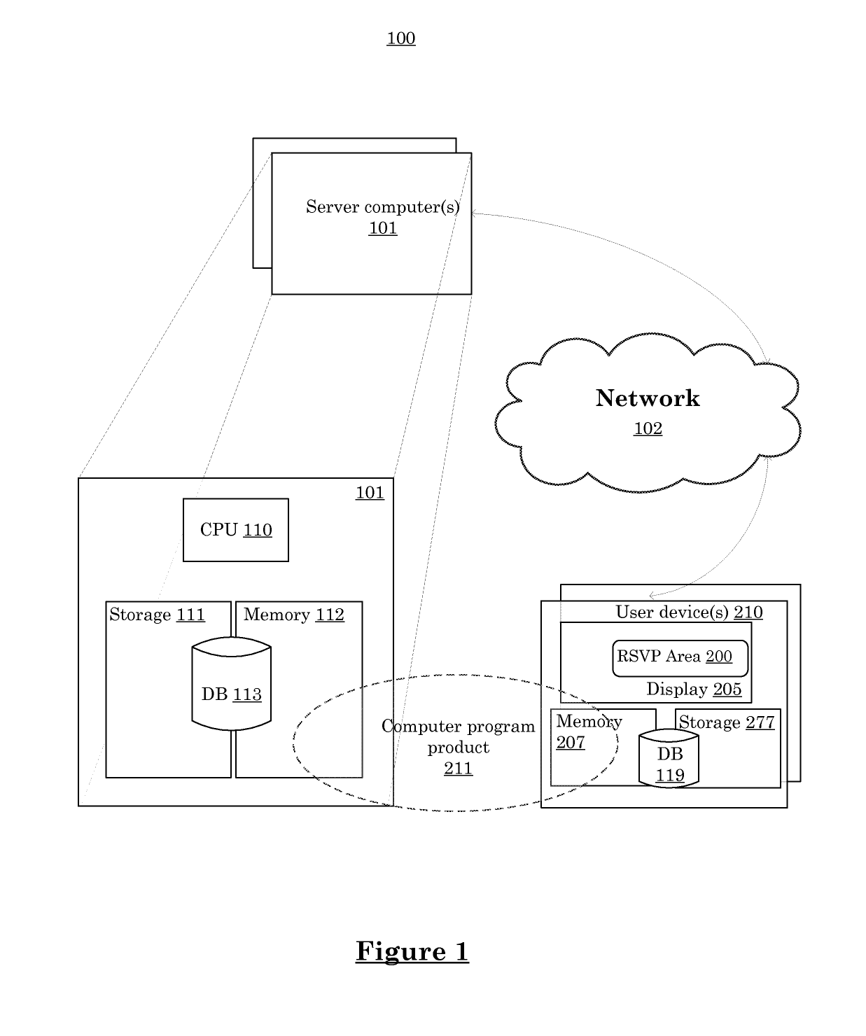

Referring to FIG. 1, computer system 100, according to an embodiment of the present invention includes one or more server computers 101, network 102, one or more user devices 210 and computer program product 211. Computer program product 211 may be provided in a transitory or non-transitory computer readable medium; however, in a particular embodiment, it is provided in a non-transitory computer readable medium (e.g., persistent (i.e., non-volatile) storage, volatile memory (e.g., random access memory), or various other well-known non-transitory computer readable mediums).

User device 210 includes display 205 memory 207, storage 277, and database 119. Display 205 may be implemented as a touch screen display but is not limited thereto. Display 205 further includes designated Rapid Serial Visual Presentation (“RSVP”) display area (DRDA) 200 on display 205.

Server computer 101 further includes central processing unit (CPU) 110, storage 111, memory 112 and database (DB) 113. Server computer 101 may be any computing device capable of hosting computer product 211 for access by one or more client computers, for example user device 210, over a network such as the Internet, for example network 102. Server computer 101 communicates with one or more client computers via the Internet and may employ protocols such as the Internet protocol suite (TCP/IP), Hypertext Transfer Protocol (HTTP) or HTTPS, instant-messaging protocols, or other protocols.

Memory 112 and 207 may include any known computer memory device. Storage 111 and 277 may include any known computer storage device.

Although not illustrated, memory 112 and 207 and/or storage 111 and 277 may also include any data storage equipment accessible by the server computer 101 and user device 210, respectively, such as any memory that is removable or portable, (e.g., flash memory or external hard disk drives), or any data storage hosted by a third party (e.g., cloud storage), and is not limited thereto.

DB 113 may reside in both memory 112 and storage 111 to provide optimized seek time and response time. Similarly, database (“DB”) 119 may reside in both of memory 207 and storage 277. In some implementations described herein, a database such as DB 119 does not necessarily need to be separately maintained on the user device. However, in some implementations, maintaining a user-side database for the presentation and tracking systems and methods described herein will be beneficial. In some embodiments, DB 113 is maintained on the user device 210 so that the data collected by the tracking systems and methods described herein will remain private for that user. In such embodiments, the aggregation of data and associated analytics by the methods described herein are applied only on the user device 210 and only some of the analytics data may be maintained on a server computer 101.

User device(s) 210 and server computer(s) 101 access and communicate via the network 102. Network 102 includes a wired or wireless connection, including a Wide Area Networks (WANs) and cellular networks or any other type of computer network used for communication between devices.

The content tracking system, according to an embodiment of the present invention, is implemented on user device 210 and server computer 101 by computer program product 211. Specifically, computer program product 211 includes instructions for executing the content tracking method and system on server computer 101 and user device 210 and the instructions are stored on computer readable memory 112 and memory 207, respectively. Computer program product 211 includes instructions to serially present text in the DRDA 200 and to execute tracks for carrying out related content tracking and content selection and presentation methods described further herein. In some embodiments, portions of computer program product 211 are distributed across multiple servers and devices.

User device 210 may include any type of electronic device capable of controlling text display. Some examples include desktop computers and portable electronic devices such as mobile phones, smartphones, multi-media players, e-readers, tablet/touchpad, notebook, or laptop PCs, smart televisions, smart watches, head mounted displays, and other communication devices. In some implementations (e.g., a smart phone or e-reader), the display 205 may be packaged together with the rest of device 210. However, in other implementations, a separate display device (e.g., a monitor) maybe be attached to device 210. While the illustrated embodiment shows a graphical border around DRDA 200, DRDA 200 simply refers to a region (e.g., a window) on display 205 where text is serially presented in accordance with an embodiment of the present invention and in particular implementations, DRDA 200 may or may not be outlined by a graphical border.

In the illustrated embodiment, computer program product 211 is loaded into memory 207 to configure device 210 in accordance with the present invention. In one embodiment, text data may be loaded into memory for text processing and display processing by device 210 as will be further described herein. Text data loaded into memory for text processing and display processing may be retrieved from persistent storage on a user device such as device 210 and/or may be received from one or more server computers 101 through a connection to network 102 (e.g., the Internet). One or more server computers 101 may be for example, one or more advertiser computers, one or more search engine computers, one or more web servers, one or more application servers, etc. In an alternative embodiment, at least some processing/pre-processing of text data for display in accordance with the principles illustrated herein may be carried out by one or more remote computers such as server computers 101 and then sent to end user device 210 for display in DRDA 200 on display 205. In such an alternative, some or all of a computer program product such as computer program product 211 for implementing an embodiment of the present invention may reside on one or more computers such as server computers 101 that are remote from end user device 210. In some embodiments, the entire computer program product may be stored and executed on remote computers and the results presented within a browser application component (e.g. a media player application) of user device 210 (browser application and media player application not separately shown).

Although not illustrated in the drawing, user device 210 also includes a processor and an input and output subsystem. In some implementations (e.g., a smart phone or e-reader), user device 210 may include a wireless transceiver and one or more input interfaces including a touch enabled display, a trackball, keyboard, microphone, smart television controller, etc.

User content, including textual data is loaded into memory 112 and/or memory 207 for text processing, display processing, and tracking, as further described herein. Text data loaded into memory for text processing and display processing may be retrieved from persistent storage on a user device such as device 210 and/or may be received from one or more server computers 101 through a connection to network 102 (e.g., the Internet).

One or more server computers 101 may include, for example, one or more advertiser computers, search engine computers, content provider computers, broadcasting provider computers, web servers, application servers and the like. Some of the content tracking and processing, including textual content tracking and processing, may be carried out by one or more remote computers such as server computers 101 and then sent to end user device 210 for RSVP display in DRDA 200 on display 205. The results of the processed content, including textual content, may be presented within a browser or other software application installed on user device 210. In some embodiments, the processing for RSVP display and content tracking may occur entirely offline on user device 210 and, optionally, the results of the content tracking methods described herein may then be transmitted to server computer 101 when a connection to network 102 is available.

According to an aspect of the present invention, content providers and advertisers may determine content and sequence of serial display and sub-displays. Additionally, a user may specify in user preferences used to determine sequencing and sorting of serially displayed content and how to choose or sort the sub-content. The content served as sub-content may be based on keywords or concepts corresponding to the words that have been serially displayed from the content.

Program product 211 may be configured to enable system 100 to take into account preferences of multiple entities, for example, the user, content providers, and advertisers, when serially presenting content in serial display and sub-display. Alternatively, program product 211 may be configured to only apply the settings and preferences of one of the entities or always override all settings based on a specific settings profile.

In an embodiment of the invention, text (which includes, for example, strings of characters—e.g., letters, numbers, symbols, etc.—which constitute words, numeric figures, and combinations of both with punctuation marks and symbols—note that words may include words represented by any human language including, without limitation, words represented by roman characters, script elements, or pictographic characters—) is presented serially (for example, one word at a time) within DRDA 200. As referenced herein, a “display element” will refer to a group of text data that is displayed at one time within DRDA 200. In other words, display elements are displayed serially. In the primary embodiment discussed herein, a display element will generally consist of one word. However, in alternative embodiments, two words may be presented as a single display element. Also, in the primary embodiment, two words are sometimes part of a single display element such as, for example, when a number, e.g., “9,” is displayed together with a unit, e.g. “feet,” so that, for example, the text “9 feet” may constitute a single display element and be presented together. Also, some languages have a somewhat different structure than English with respect to how words or word parts are typically grouped together in meaningful units. For example, in Chinese, many words require placement in short phrases (for example, two-word phrases) to form a set of characters that together have a clear meaning. Therefore, in some embodiments, a display element may comprise a short phrase (for example, two words) in a single display element.

In a conventional RSVP system, each word is centered in the display area, and the optimal fixation position shifts as words of differing lengths are sequentially displayed, resulting in saccade movements as the eyes shift to the optimal fixation position. The reader has to refocus on the display every time a new word appears that is of a different length than the previous word. The reader's eyes will move from one character to the next to find the optimal position, which is also referred to as a recovery saccade. When reading text in lines in a traditional paragraph display, most saccadic movement is from left to right so the reader is accustomed to this type of eye movement. Only occasionally, if the optimal fixation position is not found directly, the reader may have to move back from right to left. However, reading using conventional RSVP causes abnormal saccades (right to left) much more frequently than reading traditional left to right text (this is even more likely when a longer word follows a shorter word in conventional RSVP). Conventional RSVP approaches offer no solution to these problems. In order to prevent or minimize recovery saccades in an RSVP, it is preferable to display each word such that the optimal fixation position does not shift in the display. The focal point of the reader can then remain fixed on the optimal fixation position, which is a specific point in each word that is determined by the total number of characters or width of the word. This Optimal Recognition Position (ORP), can be identified in the display such that the reader's eyes are directed to focus there as the words are serially presented. An RSVP which incorporates an ORP is hereinafter referred to as “ORP-RSVP.” With an ORP-RSVP, text can then be presented at a faster rate because no saccades occur during the presentation. In addition, the elimination of saccades reduces eye fatigue and makes it more comfortable, resulting in a better reading experience for the user. Embodiments described herein may be implemented using conventional RSVP or ORP-RSVP.

With respect to embodiments implemented using ORP-RSVP, a corresponding method embodiment for serially displaying text on an electronic display comprises identifying an ORP for a plurality of words to be displayed and serially displaying the plurality of words such that the ORP of each word is displayed at a fixed display location on the electronic display. In some embodiments, the ORP is identified as a character in the word. In another embodiment, the ORP is identified as a proportionate position relative to the width of the word in pixels. In some embodiments, visual aids are used to mark the fixed display location (see e.g., hash marks) and/or an ORP within the word (e.g., different colored font). In some embodiments, words that are longer than a predetermined amount are displayed so that the fixed display location is closer to the beginning than to the end of the word.

Also, in some embodiments, a word having a length of greater than the eye's visual span (in alphabet-based languages like English or German, for example, this length might be thirteen characters, however, for other languages, it might be less, for example, in Chinese character based languages, it might be five or six characters) is divided into first and second display elements such that a first portion of the word is displayed first (along with a hyphen) and then the second portion of the word is displayed next. In some embodiments, an empirically determined ORP of each display element is presented at a fixed location of the DRDA 200. For example, each word of a plurality of words is serially presented and positioned in the display such that the ORP is displayed at a fixed display location within DRDA 200 and this enables recognition of each word in succession with minimal saccade by the reader. Determining and displaying the ORP for display elements, and presenting display elements within DRDA 200 is described in more detail in co-pending U.S. application Ser. No. 13/547,982, which is incorporated by reference above.

Configuring text content for RSVP display may include parsing text into a plurality of display elements, inserting blank elements at the end of a sentence, and determining a multiplier for each display element that can be used, along with user selected settings and/or other display parameters, to determine a display time for each display element. While, in some embodiments, each element may be displayed for the same amount of time, it has been demonstrated empirically that a longer display time is beneficial for comprehension of longer words. It has also been demonstrated empirically that a longer pause between sentences is beneficial for comprehension of longer sentences. Further details of certain systems and methods for preparing and displaying text using RSVP are described in co-pending U.S. application Ser. No. 13/547,982 referenced above.

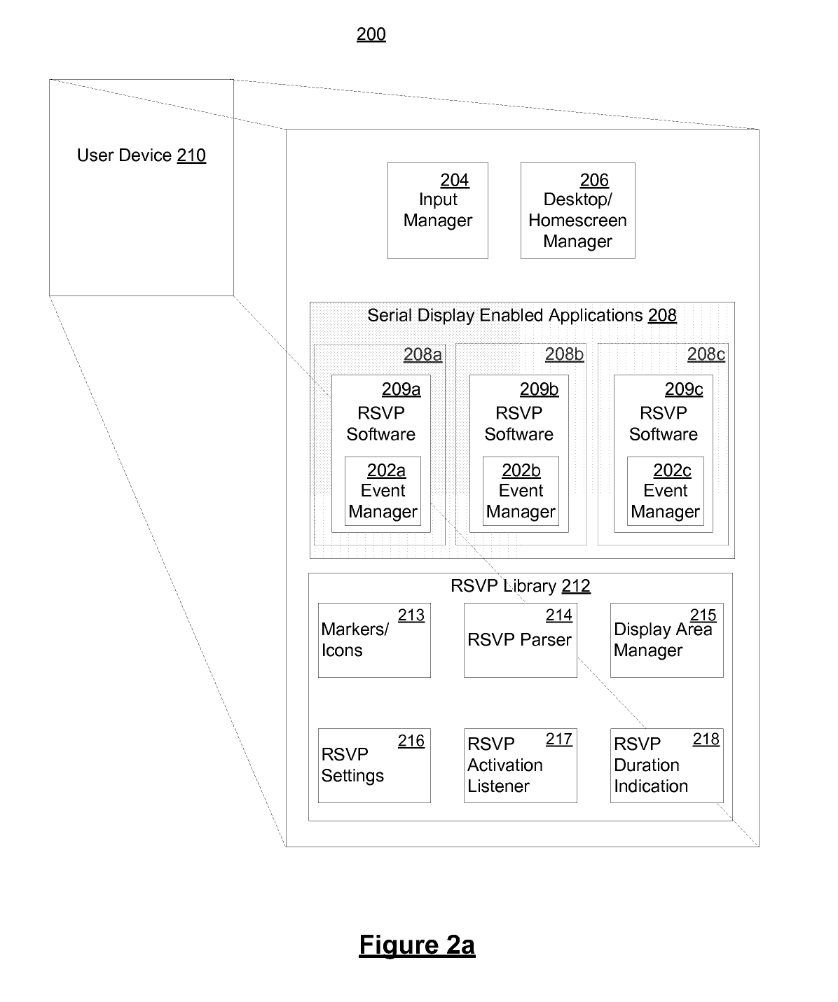

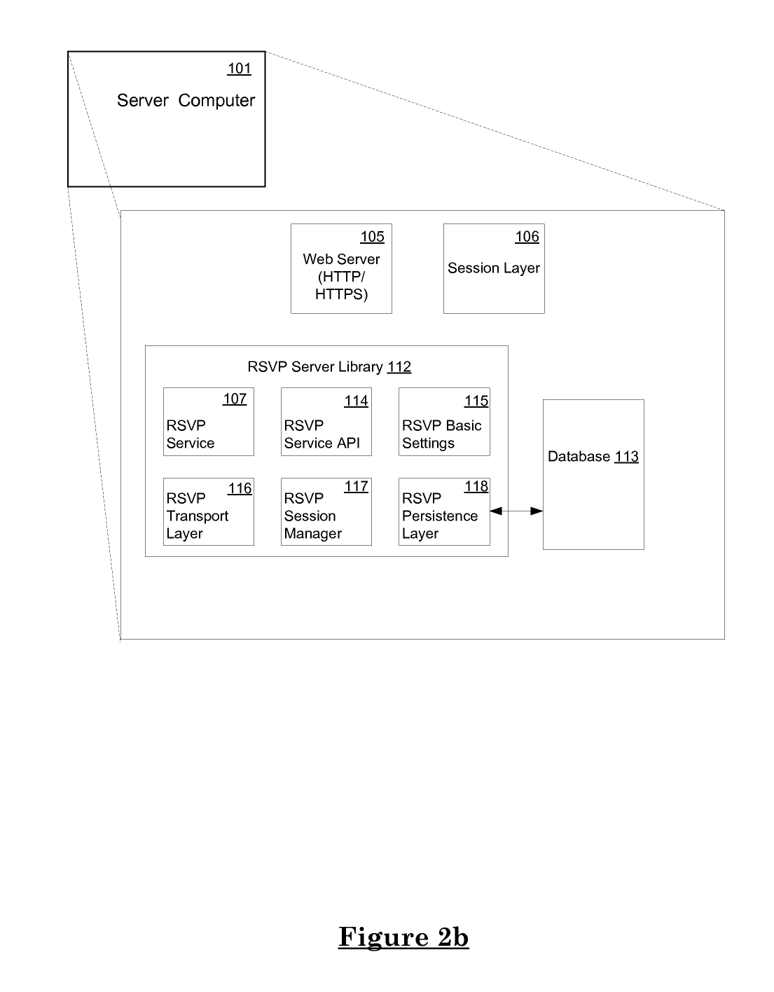

FIG. 2a is a block diagram illustrating the configuration of user device 210 of FIG. 1 and the software modules included in the portion of computer program product 211 loaded on user device 210. A number of modules are illustrated inside user device 210 to indicate modules in the device associated with text display functionality in accordance with an embodiment of the present invention. Serial display enabled applications 208 include program instructions stored on user device 210. The configuration of the modules is illustrated separately in FIG. 2a for clarity of explanation and is not limited to this specific configuration. The modules may be configured as a single combined module or configured within other modules within user device 210.

User device 210 includes desktop/homescreen manager 206 to control various elements to be displayed on a homescreen (e.g., a “homescreen” of a smart phone running a mobile operating system such as iOS™, Android™, or Windows Phone™ or a “desktop” display of a PC, laptop, etc., running an operating system such as Windows™, or Mac™ OS; or a homescreen/desktop screen of an intermediate portable device such as notepad, touchpad, e-book reader, smart watch, head mounted display etc. running a corresponding operating system). For example, desktop/homescreen manager 206 may control the icons, widgets, tiles, windows, folders, etc. and other information that may be displayed on a desktop or homescreen. Input manager 204 manages inputs received from one or more input mechanisms such as a touch-screen, trackball, keyboard, mouse, microphone, eye-tracking, a gesture detector, or other natural interface input detector, etc. For example, text input may be provided using a virtual (i.e., touch screen) or physical keyboard, mouse, trackball, etc. Alternatively, or in addition, a user may provide voice/speech input via a microphone, which may then be converted to text. Various serial display enabled applications 208 (including, for example, applications 208a, 208b, and 208c) may run on the device and may provide data to be displayed through desktop/homescreen manager 206.

Information received from the network, such as from one or more remote servers, may be provided to the applications 208 by an RSVP event manager 202 of the corresponding application, and information may be passed from applications 208 back to the network. An RSVP event manager 202, for a corresponding application (e.g., event manager 202a, 202b, or 202c within, respectively, RSVP software 209a of application 208a, RSVP software 209b of application 208b, or RSVP software 209c of application 208c) may manage notification events that are presented to a user, e.g., through display 205. For example, an event manager 202 for a corresponding application 208 may receive notification events from the wireless network. Notification events may include, for example, receipt of text messages, emails, voicemails, social network updates, file transfers, etc. An event manager 202 may in turn forward the notification events to corresponding applications. The application may then instruct the desktop or homescreen manager 206 to display status or notification information to alert the user.

As will be described in further detail below, RSVP library 212 allows user device 210 to present display elements using RSVP. In accordance with an embodiment of the present invention, applications 208a, 208b, and 208c, which may be news reading applications, book reading applications, social networking applications, word processing applications, photo applications, map applications, webpage editors, browser applications, search applications, video application, augmented reality applications, etc., may communicate with RSVP library 212 through an RSVP application programming interface (API) (not separately shown). For example, each application 208a, 208b, and 208c may include application-specific RSVP software, such as RSVP software 209a, 209b, and 209c, respectively, which may allow applications 208a, 208b, and 208c to detect presence of RSVP content. Upon detecting RSVP content, RSVP software, such as RSVP software 209a, 209b, and/or 209c may call RSVP library 212 via the API. In response, RSVP library 212 may display RSVP notification markers/icons, display DRDA 200, display RSVP content in DRDA 200, etc. In some embodiments, the application specific RSVP software, such as RSVP software 209a, 209b, and/or 209c may instead be included in RSVP library 212. In some embodiments, application-specific RSVP software, such as RSVP software 209a, 209b, and 209c may additionally include logic to allow embedding of textual content within a file.

The RSVP library 212, in accordance with an embodiment of the present invention, includes RSVP parser 214, designated RSVP display area manager 215, RSVP settings 216, RSVP activation listener 217, and RSVP duration indication 218. Although the software modules are illustrated separately in this example for clarity of explanation, one or more modules may be combined or arranged in other ways.

RSVP parser 214 parses textual data into individual display elements suitable for display in DRDA 200. Alternatively, a parser may be invoked before serving content to a user. Designated RSVP display area manager 215 displays DRDA 200 when appropriate user input is received. Appropriate input includes a system event that notifies the RSVP library 212 that user-selected content is serially displayable, in offline or online mode, to serially display content automatically or user-initiated input requesting RSVP display of the content.

RSVP settings 216 include settings related to displaying display elements using RSVP such as, the speed of display, font, font color, selection of the type of user input to activate RSVP display, block size for textual content and the like. RSVP activation listener 217 detects appropriate user input which is intended to select a RSVP notification marker/icon. RSVP duration indication 218 determines the duration of the RSVP content, which may be displayed, for example adjacent to DRDA 200. In some embodiments, the duration may be displayed as an amount of time (e.g., in seconds). Alternatively, or in addition, the duration may be displayed graphically, for example as a status bar. The duration of RSVP content may be computed, for example, based on reading speed. In this case, if reading speed is 500 words per minute, and the content contains 1000 words, then the duration is computed as two (2) minutes.

FIG. 2b illustrates a configuration of server computer 101 of FIG. 1, according to an embodiment of the present invention. Server computer 101 is in communication with the serial display enabled applications 208 included on various user devices, as described with reference to FIGS. 1 and 2a above. Server computer 101 includes a web server 105 for HTTP/HTTPS connection, and a session layer 106. Server computer 101 is configured by a portion of computer program product 211 to include RSVP server library 112. RSVP server library 112 includes RSVP service 107, RSVP service API 114, RSVP basic settings 115, RSVP transport layer 116, RSVP session manager 117 and RSVP persistence layer 118. RSVP persistence layer 118 interfaces with database 113 to update and retrieve tracked information.

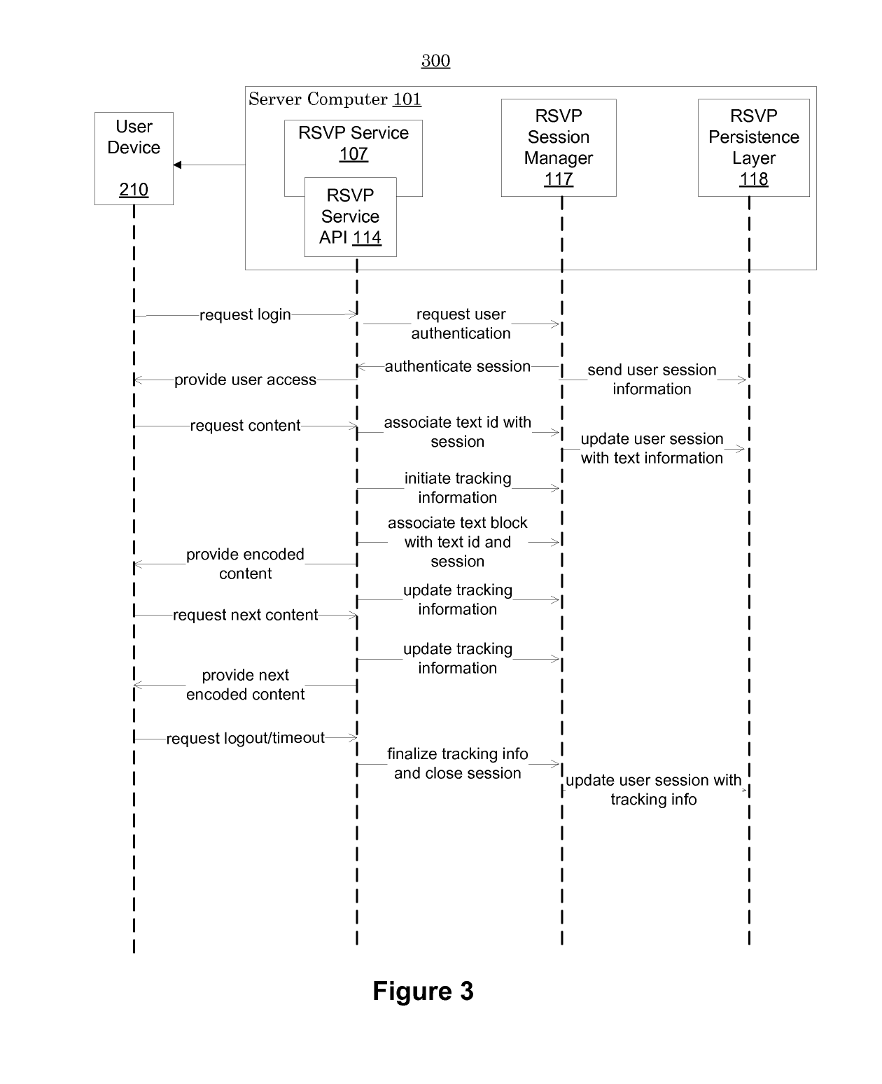

FIG. 3 is a process flow diagram illustrating a method 300, for serially displaying and tracking content including textual content, according to an embodiment of the present invention. Each process flow in FIG. 3 includes the steps and the data necessary to carry out those steps. In FIG. 3, user device 210 communicates with server computer 101 requesting textual content and providing tracking information.

User device 210 sends a login request to server computer 101. The request is processed via RSVP API 114 by RSVP service 107. RSVP service 107 requests user authentication from the RSVP session manager 117 which responds by authenticating the session. The RSVP service 107 responds to user device 210 and provides user access. The RSVP session manager 117 sends user session information to RSVP persistence layer 118. Although FIG. 3 illustrates the use of a user login/authentication, embodiments of the present invention are not limited thereto. A user login may not be necessary, for example, when tracking unrestricted content. User activity may be tracked without login credentials, for example by using temporary session variables, or other user tracking techniques may also be utilized in various implementations of embodiments of the present invention.

User device 210 proceeds to request content from RSVP service 107. RSVP service 107 associates the Text ID with the user session and provides the information to RSVP session manager 117. The RSVP session manager 117 updates the user session with text information and provides the updated information to RSVP persistence layer 118. RSVP service 107 initializes tracking information and updates RSVP session manager 117. RSVP service 107 associates the text block with the Text ID and session and provides the information to RSVP session manager 117.

RSVP service 107 provides encoded content to user device 210. The RSVP service 107 updates tracking information and provides the information to the RSVP session manager 117. For example, the text block information is used to update the tracking information.

After user device 210 finishes displaying the requested content, the device requests the next content from the RSVP service 107. The RSVP service 107 updates tracking information and provides the information to the RSVP session manager 117. The RSVP service 107 provides the next encoded content to user device 210.

When the display and tracking is finished or timed out, user device 210 requests logout/timeout from RSVP service 107. The RSVP service 107 updates and finalizes the tracking information, closes the session and provides the information to the RSVP session manager 117. The RSVP session manager 117 updates user session with tracking information and provides the updated information to the RSVP persistence layer 118.

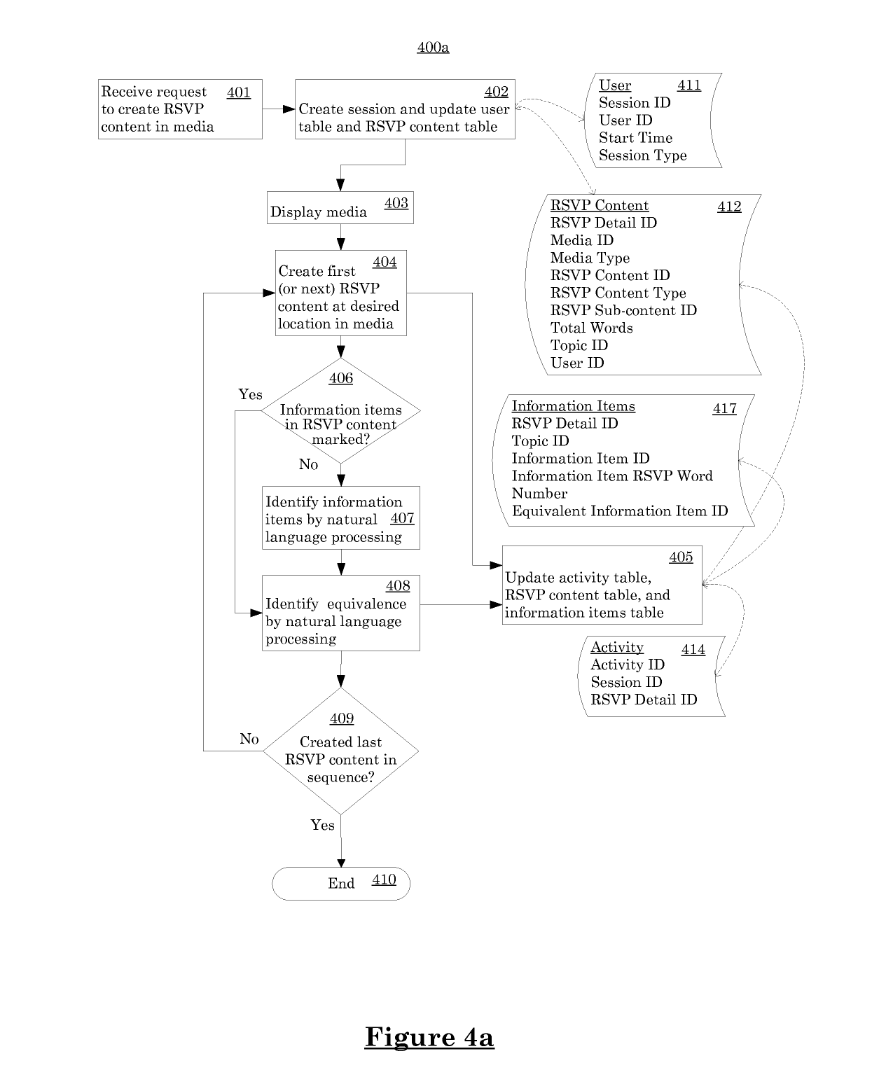

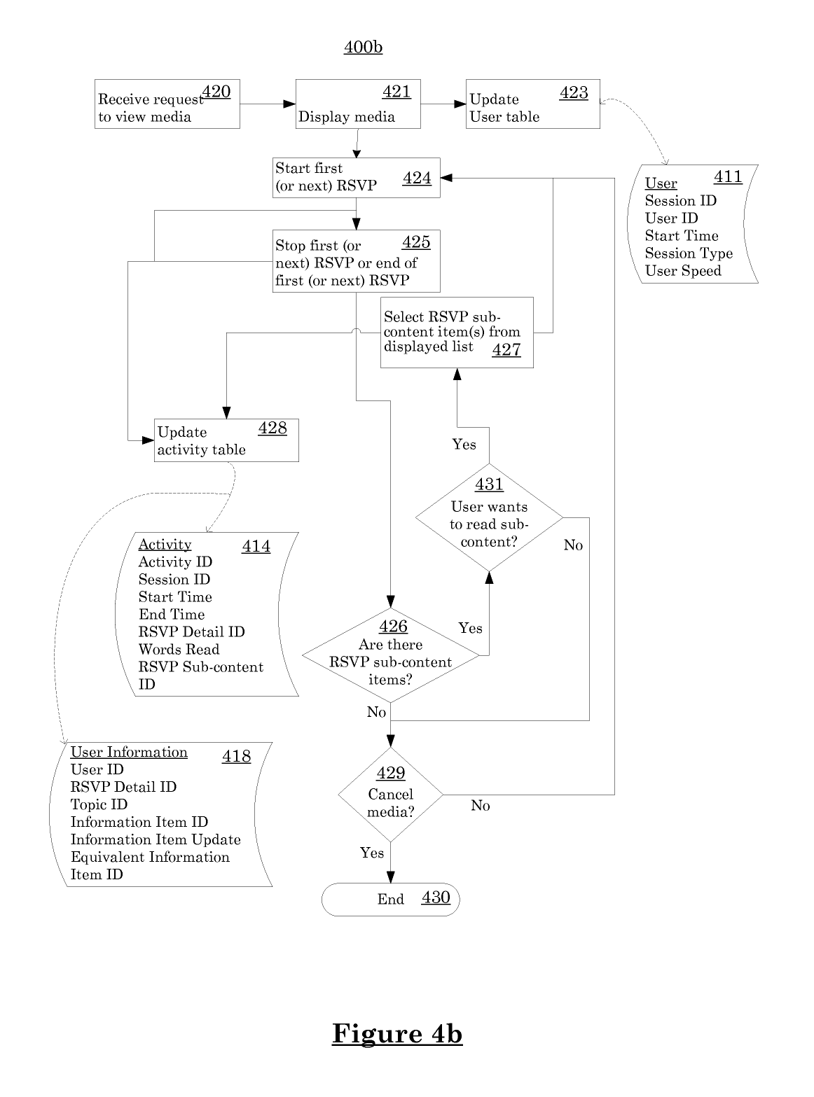

The tracking techniques described herein may be applied to any content, including textual content that can be divided into displayable elements and serially displayed. The divided elements may be treated as words and the use of content, including textual content, may be tracked by the tracking methods and systems described herein. Further, analytics can be performed for serial displays that are classified by the type of media that contain integrated serial displays. One example of tracking the creation and consumption of mixed media content that includes RSVP content and other content is shown in FIGS. 4a and 4b.

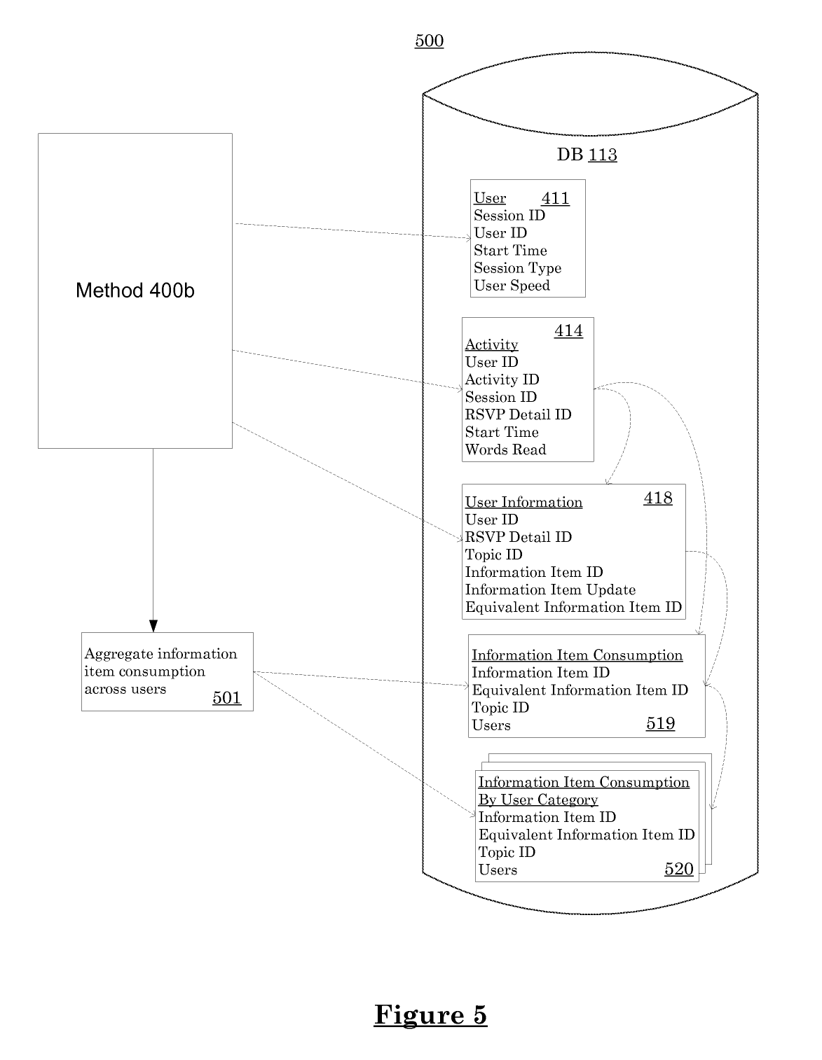

FIGS. 4a and 4b are process flow diagrams illustrating methods 400a and 400b for tracking the creation and viewing of RSVP content integrated in media to capture data that can be used for analytics, according to an embodiment of the present invention. In particular, the methods illustrated provide for tracking RSVP creation and consumption information to readily allow for aggregating data about consumption of a particular media item across multiple users (aggregating the data gathered using the methods illustrated in FIGS. 4a-b is discussed further in the context of FIG. 5). Media types that can include or be intermixed with RSVP content may be, for example, texts, photos, maps, and videos. FIGS. 4a and 4b are described in the general context of any media type. In general, RSVP text may be tracked and analyzed when it is created and then later consumed to produce various metrics.

FIG. 4a is a process diagram illustrating a method 400a for tracking data related to creation of RSVP-enhanced media. Step 401 receives a request to create RSVP content in a media item. The request may be generated as a result of a system event indicating that RSVP content creation functionality has been activated by the user on a webpage containing a media item (e.g., an article, story, photo, map, video, or mixed-media item) or that itself is a media item (e.g., a user page, product page, home page, etc.). It may also be generated automatically by the system when the RSVP application is launched to edit a media item or by a predetermined user input. The request may also include session information or login credentials, including for example, user specific information extracted from user settings or server settings, such as editing preferences.

Step 402 updates user table 411 by storing values for Session ID (identifying the request), User ID (identifying the user), Start Time (establishing the time stamp for the initiation of that session), and the Session Type (indicating whether the session is for creating RSVP or viewing RSVP content—in this case, the former). Step 402 also updates RSVP content table 412 with values for Media ID (identifying the media item that to which the user has requested to add RSVP content), Media Type (identify whether the media request is for video, photo, picture, map, or text), and the User ID (connecting RSVP content table 412 to the user session identified in table 411). In many cases, RSVP content is added to and/or associated with an existing media item and/or a media item is comprised of multiple RSVP content items. However, in some cases, an RSVP content item might be created such that it is, by itself, a media item. In those cases, the media item and RSVP content item are co-extensive.

Step 403 displays the requested media item in the RSVP-enabled application. Step 404 creates, based on user input, the first RSVP content item, i.e., a particular segment of text to be displayed by RSVP either as global content associated with the entire media item, or as embedded content associated with a particular location within the media item. The word “embedded” in this context simply means that it appears as “local” content within the media item, i.e., in association with a particular part (i.e., visual location and/or time location) of the media item. Various interfaces for viewing and creating RSVP-enabled media as well as RSVP sub-content are described in co-pending U.S. patent application Ser. No. 13/730,163 filed Dec. 28, 2012, incorporated herein by referenced. The presence of additional levels of content (sometimes referenced herein as “sub-content,” which may include various types of additional linked content such as RSVP-enabled text, photos, maps, videos, urls, or various other types of attachments) may be indicated by, for example displaying a notification similar to the notifications used to indicate the presence of an attachment and/or URL (e.g., a title or icon that is hyperlinked to the sub-content item). Interfaces for viewing and creating RSVP-enabled videos and RSVP-enabled video previews are more fully described in co-pending U.S. patent application Ser. No. 13/919,848 filed Jun. 17, 2013, incorporated herein by reference above.

As the text in an RSVP content item is created in step 404, a topic or topics may be designated for that RSVP content item, based on user input or by natural language processing (“NLP”) algorithms designed to categorize a full text. Also, as the text in the RSVP content item is created in Step 404, certain text segments within the RSVP content item may be designated and marked as information items, based on user input or by natural language processing (“NLP”) algorithms designed to identify proper nouns, nouns, and relevant word combinations (for example, noun phrases). Identifying information items (sometimes referred to as “information extraction”) is a well-known branch of NLP. Designation of part of a text as an information item could be simply a choice made by any person responsible for tagging or otherwise electronically marking parts of a text as information items. However, products implementing algorithms for identifying various information items in text are also well known and the preferred product for a given implementation will depend on the application. In some examples, identifying proper nouns and/or related phrases that include and/or modify those proper nouns (e.g., a proper noun along with associated verbs, adjectives, other nouns, or other parts of speech) will be sufficient. In other examples, other words relevant to information about particular things, for example, other nouns (including pronouns and nouns that are not proper nouns) and associated noun phrases (which may include nouns along with associated verbs, adjectives, other nouns, or other parts of speech) may also be identified as information items. Note that sometimes information items to be identified might be associated with a word that could be used as a noun or a verb depending on context, e.g., “running” or “driving.” One example of a product usable for identifying noun and noun phrase information items is the Rosette® Entity Extractor provided by Basis Technology Corporation (see www.basistech.com/text-analytics/rosette/entity-extractor/; also see Rosette® Entity Resolver at www.basistech.com/text-analytics/rosette/entity-resolver/). Step 406 determines if the information items in the RSVP content have been marked (which may, in one embodiment, be accomplished through a defined html tag). If no, then step 407 identifies the information items by NLP algorithms. The position of each information item within the RSVP content item may be identified by the number of the first word in the information item in the overall sequence of words in the RSVP content item. If the result of step 406 is yes (i.e., the information items are already marked), then the process proceeds directly to step 408.

After step 406 or step 407, step 408 compares the information items in the RSVP content to all information items for all RSVP contents that have the same Topic ID in information items table 417. Exact matches in the wording of each information item may not be required, as different wording or word sequences in information items may be equivalent. Natural language processing techniques, as well known in the art, may be applied to establish equivalence. Other approaches such as similarity lists or word clusters may be utilized to establish equivalence between two or more information items. If step 408 identifies any sets of two or more information items that are determined to be equivalent, then Equivalent Information Item IDs are created and each information item in the same set is given the same Equivalent Information Item ID for that equivalent information item. After all equivalent information items are identified, the process continues to step 405 and step 409.

Step 405 updates activity table 414 by adding and relating values that are associated with the Session ID including values for the following variables: Activity ID (which is used to record the creation or viewing of an RSVP content item in the session—in this case the former) and the RSVP Detail ID (which uniquely identifies a particular RSVP content item in association with a particular Media ID and RSVP Content ID). Step 405 also updates RSVP content table 412 with the User ID and values for RSVP Content ID (identifying that RSVP content item in association with a particular Media ID), RSVP Detail ID (described above), and RSVP Content Type (identifying the type as global or embedded), Total Words (the number of words in that RSVP content), and Topic ID (identifying each topic that has been designated for that RSVP content item). Step 405 also updates information items table 417 for each information item identified in Steps 406 and 407, with the Information Item ID (uniquely identifying each information item), Information Item RSVP Word Number (identifying the position of the information item in the RSVP content item), Topic ID (identifying a topic or topics that have been designated for the RSVP content item in which the information item appears), Equivalent Information Item ID (used to link the information item to other information items that step 408 identifies as equivalent) and RSVP Detail ID (uniquely identifying that RSVP content item).

Step 409 determines if additional RSVP content items are to be created. If yes, then the process proceeds back to step 404. If no, then the process ends at step 410 and the session is concluded.

Table 1 shows one example of an RSVP tracking database table for tracking content, including textual content, as described herein. In this example, three RSVP content items have been created by a content provider. The three RSVP content items are shown below with the information items (in this case marked by the content provider) underlined. The representation of information items in a report table can be condensed in some cases by using some of the words in the information item. The underlined words that are also shown in bold below are used to represent the corresponding information item.

Content Item R3:

“At first, the idea of starting over scared us. So much had changed since the original 1969 Stingray but one thing remained the same—the spirit that the car evoked and the way that it made people who drove it feel. The car went without an official name for 3 years while we designed, engineered, upgraded, argued and tested—we made a pact that unless the team built a Corvette worthy of the original Stingray that it wouldn't share the name. On the day that the first car that would become the production version of the 2014 Stingray came off of the line it was unanimous. We had built a Stingray. The stats were impressive, 465 horsepower thanks to an 11.5 to 1 compression ratio, carbon fiber roofing and all new electronic control systems all in a 3300 lb package. Every new potential technology available had been reviewed and most of them tested and evaluated by the time we were done.”

Content item R4:

“One of the most memorable things about the '69 Stingray was the way that it made you feel when you drove it. The car always behaved as you expected it to and always felt like an extension of the driver. Given the fact that the engine in the new Stingray is both the most powerful and the lightest engine that we've ever produced, we needed to re-engineer things from the ground up, starting with the frame. The frame on the new Stingray is 100% aluminum making it both stronger and lighter than previous Corvettes. In addition to using aluminum for the frame we integrated carbon fiber throughout the chassis and even developed a patented process to properly bind it to the other parts of the car. Our team's attitude of not settling for anything less than perfection can be felt from the second that you get behind the wheel.”

Content item R5:

“One area that our engineering team was excited to tackle was the integration of all systems within the car into a single, autonomous one that allows all the systems in the car to have access to everything that the other systems see and adjust accordingly. From brakes to steering and traction control all of the onboard systems in the Stingray communicate with each other, constantly updating and making decisions based upon the state of the entire car. As a result, the 2014 Stingray ‘understands’ the concept of driving in heavy rain and coordinates with all of the onboard systems to operate effectively together instead of each system doing its own thing. You'll only find technology like this in the new 2014 Corvette Stingray, the new American Legend.”

Table 1 shows the information in information items table 417 for these three content items, all of which have the same Topic ID T1 (not shown).

TABLE 1
Information Items Example

| | | | | Information |
|---|---|---|---|---|
| RSVP | | | Equivalent | Item RSVP |
| Detail | Information | | Information | Word |
| ID | Item ID | Information Item | Item ID | Number |
| R3 | 103-01 | original 1969 Stingray | E-001 | 16 |
| R3 | 103-02 | remained the same - the spirit | E-002 | 22 |
| R3 | 103-03 | the way that it made people who drove | E-003 | 33 |
| | | it feel | | |
| R3 | 103-04 | without an official name for 3 years | E-004 | 46 |
| R3 | 103-05 | The stats were impressive | E-005 | 114 |
| R3 | 103-06 | 465 horsepower | E-006 | 118 |
| R3 | 103-07 | 11.5 to 1 compression ratio | E-007 | 123 |
| R3 | 103-08 | carbon fiber roofing | E-008 | 128 |
| R3 | 103-09 | new electronic control systems | E-009 | 133 |
| R3 | 103-10 | 3300 lb package | E-010 | 140 |
| R4 | 104-01 | the way that it made you feel when you | E-003 | 12 |
| | | drove it | | |
| R4 | 104-02 | always behaved as you expected it to | E-011 | 25 |
| R4 | 104-03 | extension of the driver | E-012 | 37 |
| R4 | 104-04 | engine most powerful | E-013 | 46 |
| R4 | 104-05 | lightest engine | E-014 | 58 |
| R4 | 104-06 | re-engineer the frame | E-015 | 67 |
| R4 | 104-07 | 100% aluminum | E-016 | 84 |
| R4 | 104-08 | stronger and lighter than previous | E-017 | 89 |
| | | Corvettes | | |
| R4 | 104-09 | carbon fiber throughout the chassis | E-008 | 105 |
| R4 | 104-10 | patented process to properly bind it | E-018 | 114 |
| R4 | 104-11 | not settling for anything less than | E-019 | 131 |
| | | perfection | | |
| R5 | 105-01 | integration of all systems | E-020 | 13 |
| R5 | 105-02 | all onboard systems communicate with | E-021 | 53 |
| | | each other | | |
| R5 | 105-03 | ‘understands’ the concept of driving in | E-022 | 84 |
| | | heavy rain | | |
| R5 | 105-04 | the new American Legend | E-023 | 124 |

In Table 1, Information Item 103-03 in RSVP Detail ID R3 and Information Item 104-Olin RSVP Detail ID R4 are equivalent and have been given the same value, E-003, for Equivalent Information Item ID. Similarly, Information Item 103-08 in RSVP Detail ID R3 and Information Item 104-09 in RSVP Detail ID R4 are equivalent and have been given the same value, E-008, for Equivalent Information Item ID.

FIG. 4b illustrates a method 400b for tracking RSVP text as it is consumed (i.e., viewed, which is generally determined by methods referenced herein based on tracking RSVP display of text on a user device) to produce various metrics.

Turning to FIG. 4b in detail, step 420 receives a request to view a media item. In some embodiments, the request may include session information or login credentials, including for example, tracking variables and user specific information extracted from user settings or server settings, such as user speed and reading level. The requested media with RSVP content is identified by its Media ID, originally generated and stored as part of RSVP Content table 412 of FIG. 4a.

Step 421 displays a media item in which RSVP content has been previously created and tracked according to the example in FIG. 4a. Step 423 then updates user table 411 by storing values for Session ID (identifying the request for the media), User ID (identifying the user), Start Time (establishing the time stamp for the initiation of that session), the Session Type (records that the session is to view—rather than create—RSVP content), and User Speed (identifying the reading speed that has been selected for displaying RSVP to the user for the current request).

Step 424 starts RSVP display of the first (or next) RSVP content segment (i.e., RSVP content item) in the media. Note that, depending on the application, the type of media item and/or settings of the author, provider, and/or user of the item, each RSVP content segment may display (at step 424) automatically in a predetermined sequence or, alternatively, may display only in response to a specific user interface action.

While the media and associated RSVP content segments are displaying, step 428 continues to update activity table 414 by adding and relating values associated with the Session ID including values for the following variables: Activity ID (which identifies a request for viewing a particular RSVP content segment that is part of the media item associated with the Session ID), RSVP Detail ID (identifying the specific RSVP content segment), Words Read (value that is incremented as additional words in the RSVP content segment are displayed), and RSVP Sub-content ID (identifying each RSVP sub-content item that has been selected by the user). Step 428 also updates user information table 418 by, for each information item viewed, adding and relating values for the User ID, the RSVP Detail ID, Topic ID (corresponding to the RSVP content item) the Information Item ID, Equivalent Information Item ID, and Information Item Update (the date of the session, i.e., the current session in which the item is viewed). Step 425 indicates that the current RSVP content segment (i.e., the segment started at step 424) has been stopped or has ended. After step 425, step 428 further updates activity table 414 to indicate the End Time (the time at the conclusion of the requested activity (e.g., the time when the RSVP content segment ends or otherwise stops displaying)).

Step 426 determines if there are any RSVP sub-content items related to the RSVP content displayed in step 424. If no, then the process proceeds to step 429. If yes, the process proceeds to step 431, where the user decides if he interacts with sub-content. If the answer is no, then the process proceeds to step 429. If yes, the process proceeds in step 427 to display a list of titles of the RSVP sub-content items from which the user can make a selection. If the user makes a selection, then step 428 updates activity table 414 with the RSVP Detail ID and RSVP sub-content ID of the selected item. Step 428 also updates user information table 418 with the RSVP Detail ID of the Topic ID of the selected item. The process then proceeds back to step 424 so that the selected RSVP sub-content item can be displayed and tracked.

Step 429 determines if display of the media has been canceled by the user (e.g., the user has navigated away from the page or otherwise stopped display of the media). If yes, then the process ends at step 430 and the session is concluded. If no, then the process returns to step 424 and the user may select another RSVP content item (or display of the next RSVP content segment may be initiated automatically) and the process is repeated until the user decides to cancel the media.

FIG. 5 illustrates process flow 500 implemented by a computer system in accordance with an embodiment of the present invention for tracking and aggregating usage data for RSVP contents for each user. Method 500 may be implemented on a user device such as user device 210 of FIG. 1 and one or more server computers such as server 101 of FIG. 1 including a database such as DB 113 of FIG. 1. In this embodiment, DB 113 stores various tracking and aggregated data related to serially displaying content and tracking content consumption. Method 500 may be distributed across multiple servers and devices.

Method 500 relies on the portion of process 400b (illustrated in FIG. 4b) required to populate user information table 411 (tracking information for the user who has viewed RSVP content), activity table 414 (tracking user activity by RSVP Detail ID), and user information table 418 (tracking information items viewed by a user). It is understood that accomplishing these steps also relies on data found in RSVP content table 412 (tracking information about created RSVP content items) and information items table 417 (tracking information about information items in RSVP content items), which are populated by process 400a illustrated in FIG. 4a.

Step 501 generates and stores in information item consumption table 519 of DB 113, the information item consumption data for each information item (identified by its unique Information Item ID), aggregated from all view sessions data. Specifically, step 501 determines and stores values for the following variables: Users (a count of total number of users who viewed that information item), Information Item ID (identifying each information item), and Topic ID (identifying each topic associated with each information item). Step 501 also generates and stores in tables 520 of DB 113, the information item consumption by user categories (such as age group, sex, income range, reading level or other typical demographics), aggregated from all data in all sessions by all users.

Although the example illustrated in FIG. 5 shows step 501 being performed using the same data tables and database represented in FIG. 4b (which in turn relies in part on data stored in tables represented in FIG. 4a), those skilled in the art will understand that, in alternative embodiments, data may be pre-filtered and/or restored on different computers and/or in similar but distinguishable databases prior to being aggregated by step 501. Such variations may be implemented for performance or other reasons without necessarily departing from the spirit and scope of the present invention.

Table 2 shows an example report of selected data in user information table 518 for a user with the User ID “U1”. (Note that, to generate the below report, the RSVP Content ID can be looked up in RSVP content table 412 using the RSVP Detail ID from table 518.)

TABLE 2
User Information Example

| | RSVP | | | | Equivalent | |
|---|---|---|---|---|---|---|
| User | Content | Topic | Information | | Information | Information |
| ID | ID | ID | Item ID | Information Item | Item ID | Item Update |
| U1 | R6 | T1 | 106-01 | lightest engine | E-014 | 2013-09-15 |
| U1 | R6 | T1 | 106-02 | engine most powerful | E-013 | 2013-09-15 |
| U1 | R7 | T1 | 107-01 | stronger than previous | E-017 | 2012-01-10 |
| | | | | Corvettes | | |
| U1 | R7 | T1 | 107-02 | lighter than previous | E-017 | 2012-01-10 |
| | | | | Corvettes | | |

Table 3 shows an example report of selected aggregated data in information item consumption table 519 for the first five information items of an RSVP content with the RSVP Content ID R3. Each column shows aggregated numbers of people who have read each Information Item over various amounts of time so that trending can be visualized.

TABLE 3
Information Item Consumption Example

| | Consumption by | Consumption by | Consumption by |
|---|---|---|---|
| Information | users within | users within | users within |
| Item ID | last hour | 5 hours | 24 hours |
| 103-01 | 5212 | 23519 | 115578 |
| 103-02 | 4889 | 21989 | 109976 |
| 103-03 | 4200 | 18366 | 91791 |
| 103-04 | 3937 | 16745 | 83896 |
| 103-05 | 1978 | 9114 | 45139 |

Table 4 shows an example report of selected aggregated data in information item consumption by user category table 520 for the same RSVP content as shown in Table 3 however Table 4 is limited to people belonging to the user category of 25 to 29 year olds. Therefore, the numbers shown in Table 4 represent a subset of those represented in Table 3.

TABLE 4
Information Item Consumption By User Category Example

| | | Consumption by | | |
|---|---|---|---|---|
| User | | users consumed | Consumption by | Consumption by |
| Category | Information | within last | users consumed | users consumed |
| ID | Item ID | hour | within 5 hours | within 24 hours |
| UC-1 | 103-01 | 943 | 4265 | 20863 |
| UC-1 | 103-02 | 870 | 3961 | 19820 |
| UC-1 | 103-03 | 769 | 3284 | 16532 |
| UC-1 | 103-04 | 701 | 3026 | 15109 |
| UC-1 | 103-05 | 326 | 1597 | 8016 |

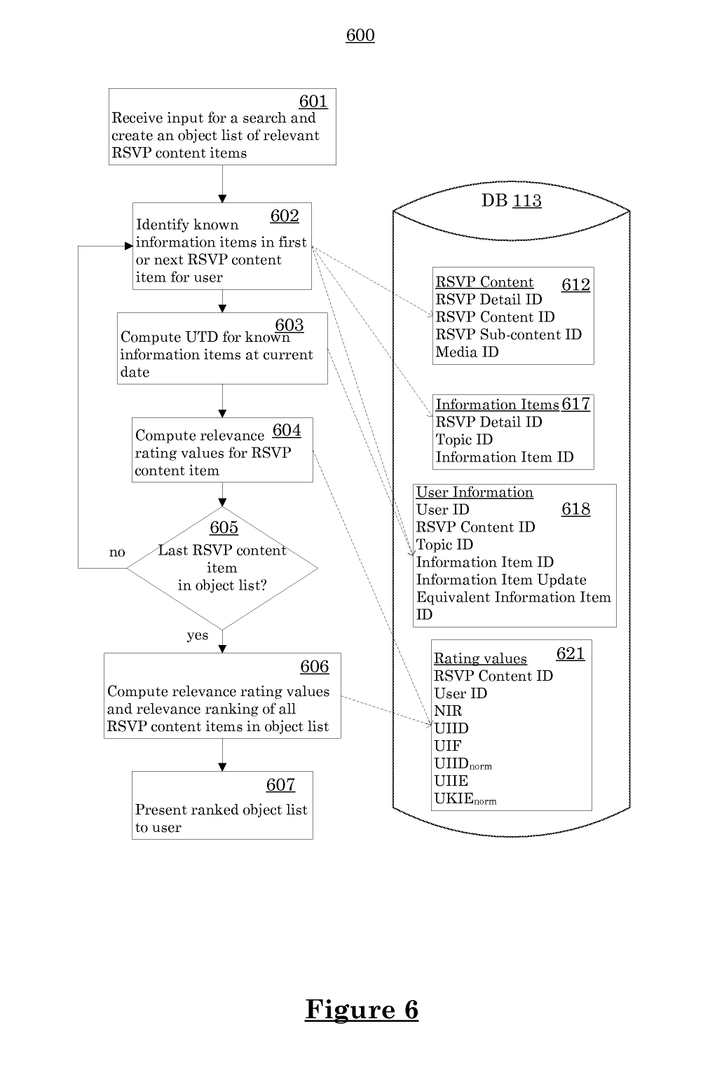

FIG. 6 illustrates process flows implemented by a computer system in accordance with an embodiment of the present invention for generating relevance rating data for RSVP contents to improve relevance of content and content listings presented to a user. The content may be published content such as news articles presented in a reading application or information portal, or it may be sponsored content such as advertisements. The content listing may also be a listing of content items determined by a computerized search based on search terms or topics chosen by the user. The content listing may be generated by a provider without input from a user, e.g. based on a profile of information about the user that has been obtained by the provider.

When a user provides a search term, an object list is extracted based on the search terms and provided to the user in the most relevant order to the user. The object list contains a list of content or pages that relate to at least one keyword or search term. The object list may be initially sorted by assigning an initial rank to each content item or page within the list. This initial ranking may be determined using one or more various known search criteria including, for example, the number of other pages that link to the page or the frequency of keywords or search terms within the content item or page. The search results object list is then enriched by the RSVP analytics data to obtain an adjusted ranking to provide more relevant results. In an alternative embodiment, the use of the RSVP analytics data could be incorporated into the algorithm generating the initial search results such that the initial results are affected by the RSVP data without requiring further enrichment.

Now referring to FIG. 6, method 600 may be implemented on a user device such as user device 210 of FIG. 1 and one or more server computers such as server 101 of FIG. 1 including a database such as DB 113 of FIG. 1. In this embodiment, DB 113 stores various rating data related to serially displaying content and tracking content consumption. Thus, process 600 may be distributed across multiple servers and devices.

RSVP content table 612, information items table 617, and user information table 618 are not necessarily intended to be distinct from RSVP content table 512, information items table 517, and user information table 518 of FIG. 5. Rather, those data structures are illustrated again in FIG. 6 so that they may be shown together and in context with the aggregated data structures generated by method 600 of FIG. 6. At the same time, in particular embodiments, data that is tracked in a method such as method 500 may, in some implementations, be restored on the same or different computers prior to being aggregated.

DB 113 includes information that has been aggregated in user information table 618 (tracking RSVP content information, including topics and information items), aggregated for each user for all sessions. DB 113 also includes RSVP content table 612 (uniquely identifying each RSVP content item), information items 617 (identifying each information item and each topic for each RSVP content) and rating values table 621 (storing the current values of the computed ratings for each RSVP content for each user).

Now turning to FIG. 6 in detail, step 601 receives search terms, generated at least in part by a user performing a search, and creates an object list of relevant RSVP content items. A user may perform a search by submitting search terms to a search application, a web browser, an RSVP enabled application, or an RSVP search ranking application implementing method 600. The user search query includes at least one keyword or search term. In cases of using a web browser, the search terms and clicks are tracked by search engines and web crawlers to generate usage data for generating search results. Step 601 extracts an object list comprised of content items and each content item has at least one word that matches one of the search terms. The object list includes search results where each entry in the list may include, for example, a sort position, a rank for the object, an object identifier, an object title, and an object preview, such as the first few characters or words of the textual content. The object list format may depend on the type of content being searched. For example, when searching photos, the object list may include a thumbnail of the photo being searched and the textual content associated with the photo, for example from the caption of the image. As another example, the content being searched may include a file being searched in a file system, an email and/or various other types of content. The sort position may be determined, for example, by how many times a file or photo has been opened or an email has been read.

In the example provided by Table 1, each of the RSVP contents have the same topic, Topic ID “T1”, which indicates “New Corvette Stingray”. These RSVP contents may then be extracted by step 601 when the user with User ID U1 makes a input with the search term “corvette”. Also, in the example provided by Table 2, this user has previously read two RSVP contents which has the same topic. Step 601 would therefore create an object list including these five RSVP contents, as shown in Table 5.

TABLE 5
Object List Example

| | RSVP | | Object |
|---|---|---|---|
| User ID | Content ID | Topic ID | Rank |
| U1 | R3 | T1 | 1 |
| U1 | R4 | T1 | 2 |
| U1 | R5 | T1 | 3 |
| U1 | R6 | T1 | 4 |
| U1 | R7 | T1 | 5 |

After step 601 extracts the object list, step 602 queries DB 113 to return all information items in the first RSVP content item. The query utilizes the RSVP content table 612 to extract all RSVP Detail IDs in that RSVP Content ID or RSVP Sub-content ID. The query can then be made to information items 617 to extract all Information Item IDs or Equivalent Information Item IDs. The query can then be made to user information table 618 for the User ID of the user to return all Information Item IDs and Equivalent Information Item IDs that match the extracted Information Item IDs and Equivalent Information Item IDs from the previous query. The matched information items are referred to as “known information items” for that user.

Table 6 shows the known information items of the example data generated in step 602 from user information table 618 for User ID U1 in the two RSVP content items from the object list of Table 5.

TABLE 6
Known Information Items Example

| | RSVP | | | Equivalent | |
|---|---|---|---|---|---|
| | Content | Information | | Information | Information |
| Object | ID | Item ID | Information Item | Item ID | Item Update |
| 2 | R4 | 104-04 | engine most powerful | E-013 | |
| 2 | R4 | 104-05 | lightest engine | E-014 | |
| 2 | R4 | 104-08 | Stronger and lighter than | E-017 | |
| | | | previous Corvettes | | |
| 4 | R6 | 106-01 | lightest engine | E-014 | 2013 Sep. 15 |
| 4 | R6 | 106-02 | most powerful engine | E-013 | 2013 Sep. 15 |
| 5 | R7 | 107-01 | stronger than previous | E-017 | 2012 Jan. 10 |
| | | | Corvettes | | |
| 5 | R7 | 107-02 | lighter than previous | E-017 | 2012 Jan. 10 |
| | | | Corvettes | | |

After step 602 extracts the known information item list, step 603 computes the up-to-dateness (“UTD”) of each known information item that is in the user information table 618 of that user. Step 603 queries DB 113 to return the Information Item Update in user information table 618 for the Information Item ID of each known information item. UTD represents an aging factor for known information items, taking into account how long ago the user read an information item. With the assumption of a maximum time span in days for knowledge retention (“Retention Days”), the UTD reduces the influence of known information items in rating the relevance of a content item. One formula for calculating UTD uses a ratio in which the Information Item Update date is subtracted from the date of the query (“Query Date”) and divided by Retention Days, as shown below:

$$UTD = 1 - \frac{Query Date - Information Item Update}{Retention Days}$$

In the above formula, if UTD is less zero, then the value returned for UTD is set to zero. UTD values close to 1 mean that the user is still familiar with the known information items in the content item. UTD values of 0 can be interpreted as an information item which has been consumed by the user before, but which he has forgotten. It will therefore not be counted as a known information item in the relevance ratings calculation in step 604. Other formulas could be applied to scale the value of UTD, such as a non-linear aging factor, or no aging factor is applied so that all known information items are considered in the relevance ratings calculations in step 604.

Table 7 shows the UTD of the example data generated in step 603 from Table 6. For the purposes of this example, the Query Date is 1 Oct. 2013 and the value of Retention Days is 365 (one year).

TABLE 7
Up-to-dateness (UTD) Example

| | RSVP | | Equivalent | Equivalent | |
|---|---|---|---|---|---|
| | Content | Information | Information | Information | |
| Object | ID | Item ID | Item ID | Item Update | UTD |
| 2 | R4 | 104-04 | E-013 | 2013 Sep. 15 | 0.96 |
| 2 | R4 | 104-05 | E-014 | 2013 Sep. 15 | 0.96 |
| 2 | R4 | 104-08 | E-017 | 2012 Jan. 10 | 0 (−0.75) |
| 4 | R6 | 106-01 | E-014 | 2013 Sep. 15 | 0.96 |
| 4 | R6 | 106-02 | E-013 | 2013 Sep. 15 | 0.96 |
| 5 | R7 | 107-01 | E-017 | 2012 Jan. 10 | 0 (−0.75) |
| 5 | R7 | 107-02 | E-017 | 2012 Jan. 10 | 0 (−0.75) |

As a result, the three information items with UTD of zero are considered to be unknown information items for the purpose of computing relevance rating values.

In step 604, relevance rating values are computed for the RSVP content item identified in step 602. Step 604 stores the computed rating values in rating values table 621 in DB 113 for the RSVP Content ID of the RSVP content item and the User ID of the user. The relevance ratings may include New Information Ratio (“NIR”), Unknown Information Item Density (“UIID”), and Unknown Information Frontloading (“UIF”).

The New Information Ratio (NIR) is the ratio of the unknown information items in the RSVP content item to the total number of information items in the RSVP content item. The number of unknown information items are calculated by subtracting the number of known information items (determined in step 602 and adjusted for UTD in step 603) from the total number of information items in the RSVP content item. The formula is shown below:

$$New Information Ratio ( NIR ) = \frac{Number of unknown information items}{Total number of information items}$$

In the above formula, if all information items are unknown to the user, the NIR is 1. If all information items are known to the user, the NIR is 0.

Table 8 shows the NIR values of the example data generated in step 604. Note that the number of unknown information items in RSVP Content ID R7 is two due to the UTD value of 0 for both information items.

TABLE 8
New Information Ratio Example

| | Number of | Total | New |
|---|---|---|---|
| | unknown | number of | information |
| RSVP | information | information | ratio |
| Content ID | items | items | (NIR) |
| R3 | 10 | 10 | 1.00 |
| R4 | 9 | 11 | 0.82 |
| R5 | 4 | 4 | 1.00 |
| R6 | 0 | 2 | 0.00 |
| R7 | 2 | 2 | 1.00 |

The Unknown Information Item Density (UIID) is a characteristic for one RSVP content item in relation to other RSVP content items. All RSVP content items in the object list created in step 601 list can be compared by computing the normalized values for the UIID of each RSVP content item. UIID is the ratio of the unknown information items in the RSVP content item to the total number of words in the RSVP content item. The number of unknown information items are calculated by subtracting the number of known information items (determined in step 602 and adjusted for UTD in step 603) from the total number of information items in the RSVP content item. The formula is shown below:

$$UIID = \frac{Total number of unknown information items}{Total number of words}$$

Table 9 shows the UIID values for the example data generated in step 604.

TABLE 9
Unknown Information Item Density Example

| | Total number | | |
|---|---|---|---|
| | unknown | Total | |
| RSVP | information | number | |
| Content ID | items | of words | UIID |
| R3 | 10 | 162 | 0.062 |
| R4 | 9 | 149 | 0.060 |
| R5 | 4 | 127 | 0.031 |
| R6 | 0 | 45 | 0.000 |
| R7 | 2 | 35 | 0.057 |

Unknown Information Frontloading (UIF) characterizes the distribution of unknown information items in the RSVP content item, as a function of the position of each unknown information item, as shown in the formula below:

$$UIF = ( {\sum }_{Unknown information {item}_{1}}^{Unknown information {item}_{n}} ( 1 - \frac{Information item RSVP word number}{Total number of words} ) ) * \frac{1}{Total number of unknown information items}$$

In the above formula, if the total number of unknown knowledge items is zero, the formula returns the value of zero. The sooner that unknown information items appear in the RSVP content sequence, the closer UIF is to the value of 1. The later that unknown information items appear in the RSVP content sequence, the closer UIF is to the value of zero.

Table 10 shows the UIF formula values for the example data generated in step 604 for each unknown information item in the RSVP content items in the object list.

TABLE 10
Unknown Information Front-loading Formula Values Example

| | | Total | | Information | | |
|---|---|---|---|---|---|---|
| | | number of | Unknown | item | | |
| RSVP | Unknown | unknown | information | RSVP | Total | 1 − (RSVP word |
| Content | information | information | item | word | number | number/Total |
| ID | item ID | items | no | number | of words | number of words) |
| R3 | 103-01 | 10 | 1 | 16 | 162 | 0.90 |
| R3 | 103-02 | 10 | 2 | 22 | 162 | 0.86 |
| R3 | 103-03 | 10 | 3 | 33 | 162 | 0.80 |
| R3 | 103-04 | 10 | 4 | 46 | 162 | 0.72 |
| R3 | 103-05 | 10 | 5 | 114 | 162 | 0.30 |
| R3 | 103-06 | 10 | 6 | 118 | 162 | 0.27 |
| R3 | 103-07 | 10 | 7 | 123 | 162 | 0.24 |
| R3 | 103-08 | 10 | 8 | 128 | 162 | 0.21 |
| R3 | 103-09 | 10 | 9 | 133 | 162 | 0.18 |
| R3 | 103-10 | 10 | 10 | 140 | 162 | 0.14 |
| R4 | 104-01 | 9 | 1 | 12 | 149 | 0.92 |
| R4 | 104-02 | 9 | 2 | 25 | 149 | 0.83 |
| R4 | 104-03 | 9 | 3 | 37 | 149 | 0.75 |
| R4 | 104-06 | 9 | 4 | 67 | 149 | 0.55 |
| R4 | 104-07 | 9 | 5 | 84 | 149 | 0.44 |
| R4 | 104-08 | 9 | 6 | 89 | 149 | 0.40 |
| R4 | 104-09 | 9 | 7 | 105 | 149 | 0.30 |
| R4 | 104-10 | 9 | 8 | 114 | 149 | 0.23 |
| R4 | 104-11 | 9 | 9 | 131 | 149 | 0.12 |
| R5 | 105-01 | 4 | 1 | 13 | 127 | 0.90 |
| R5 | 105-02 | 4 | 2 | 53 | 127 | 0.58 |
| R5 | 105-03 | 4 | 3 | 84 | 127 | 0.34 |
| R5 | 105-04 | 4 | 4 | 124 | 127 | 0.02 |
| R7 | 107-01 | 2 | 1 | 6 | 35 | 0.83 |
| R7 | 107-02 | 2 | 2 | 16 | 35 | 0.54 |

In this example, RSVP content item R6 is not shown as it has no unknown information items.

Table 11 shows the UIF values for the example data generated from Table 10 in step 604 for each unknown information item in the RSVP content items in the object list.

TABLE 11
Unknown information front-loading

| | Total number | Unknown |
|---|---|---|
| | of unknown | Information |
| RSVP | information | Frontloading |
| Content ID | items | (UIF) |
| R3 | 10 | 0.46 |
| R4 | 9 | 0.50 |
| R5 | 4 | 0.46 |
| R6 | 0 | 0 |
| R7 | 2 | 0.69 |

After step 604 is completed, step 605 determines if the last RSVP content item in the object list has been processed. If no, then the process returns to step 602 to process the next RSVP content item in the object list. If yes, the process continues to step 606.

In step 606, the relevance rating values which depend on certain values of variables of all RSVP contents in the object list are computed. Step 606 stores the computed rating values in rating values table 621 in DB 113 for the RSVP Content ID of the RSVP content item and the User ID of the user. The relevance ratings may include Unknown Information Item Density Normalized (“UIIDₙₒᵣₘ”), Unknown Information Item Exclusivity (“UIIE”), and Unknown Information Item Exclusivity Normalized (“UIIEₙₒᵣₘ”).

In step 606, the Unknown Information Item Density Normalized rating value is computed by dividing the UIID value of each RSVP content item by the maximum UIID value of all RSVP contents in the object list, as shown in the formula below:

$${UIID}_{norm} = UIID \times \frac{1}{{UIID}_{max}}$$

In the above formula, denser RSVP content items should be preferred by users as unknown information can be consumed faster. The UIIDₙₒᵣₘ of the most dense RSVP content item in the object list obtains the value of 1. All other UIIDₙₒᵣₘ values in the object list are between 0 and 1.

Table 12 shows the UIIDₙₒᵣₘ values for the example data generated from Table 9 in step 604 for each RSVP content item in the object list.

TABLE 12
Unknown Information Item Density Example

| | Total number | | | |
|---|---|---|---|---|
| | unknown | Total | | |
| RSVP | information | number | | |
| Content ID | items | of words | UIID | UIIDₙₒᵣₘ |
| R3 | 10 | 162 | 0.062 | 1 |
| R4 | 9 | 149 | 0.060 | 0.97 |
| R5 | 4 | 127 | 0.031 | 0.50 |
| R6 | 0 | 45 | 0.000 | 0 |
| R7 | 2 | 35 | 0.057 | 0.92 |

Also in step 606, the Unknown Information Items Exclusivity (UIIE) is computed for each qualified RSVP content item in the object list. An RSVP content item is qualified if it contains at least one unknown information item. The UIIE rates the importance of unknown information items in an RSVP content item. For each unknown information item, the number of appearances of it in all RSVP contents in the object list is determined. For all unknown information items of each RSVP content item, these values are summed and put into relation with the number of unknown information items included in the RSVP object, as shown in the formula below:

$$UIIE = ( {\sum }_{Unknown Information {Item}_{1}}^{Unknown Information {Item}_{n}} ( 1 - \frac{Number of appearances}{Number of qualified RSVP contents} ) * \frac{1}{Total number of unknown information items in RSVP content}$$

If an unknown information item is included in several RSVP content items in the object list, its contribution to UIIE becomes smaller. If an RSVP content item contains certain unknown information items exclusively (e.g. which are not mentioned in the other RSVP content items in the object list), then the UIIE value is high.

Table 13 shows the UIIE formula values for the example data generated in step 606 for each unknown information item in the qualified RSVP content items in the object list.

TABLE 13
Unknown Information Item Exclusivity Formula Example

| | | | Number of | 1 − (Number of |
|---|---|---|---|---|
| | | | qualified | Appearances/ |
| | Unknown | Number | RSVP | Number of |
| RSVP | Information | of Appear- | content | qualified RSVP |
| Content ID | Item ID | ances | items | content items) |
| R3 | 103-01 | 1 | 4 | 0.75 |
| R3 | 103-02 | 1 | 4 | 0.75 |
| R3 | 103-03 | 2 | 4 | 0.50 |
| R3 | 103-04 | 1 | 4 | 0.75 |
| R3 | 103-05 | 1 | 4 | 0.75 |
| R3 | 103-06 | 1 | 4 | 0.75 |
| R3 | 103-07 | 1 | 4 | 0.75 |
| R3 | 103-08 | 2 | 4 | 0.50 |
| R3 | 103-09 | 1 | 4 | 0.75 |
| R3 | 103-10 | 1 | 4 | 0.75 |
| R4 | 104-01 | 2 | 4 | 0.50 |
| R4 | 104-02 | 1 | 4 | 0.75 |
| R4 | 104-03 | 1 | 4 | 0.75 |
| R4 | 104-06 | 1 | 4 | 0.75 |
| R4 | 104-07 | 1 | 4 | 0.75 |
| R4 | 104-08 | 1 | 4 | 0.75 |
| R4 | 104-09 | 2 | 4 | 0.50 |
| R4 | 104-10 | 1 | 4 | 0.75 |
| R4 | 104-11 | 1 | 4 | 0.75 |
| R5 | 105-01 | 1 | 4 | 0.75 |
| R5 | 105-02 | 1 | 4 | 0.75 |
| R5 | 105-03 | 1 | 4 | 0.75 |
| R5 | 105-04 | 1 | 4 | 0.75 |
| R7 | 107-01 | 2 | 4 | 0.50 |
| R7 | 107-02 | 2 | 4 | 0.50 |

Table 14 shows the UIIE values for the example data generated from Table 13 in step 606 for each unknown information item in the qualified RSVP content items in the object list.

TABLE 14
Unknown Information Item Exclusivity Example

| | Total Number of | |
|---|---|---|
| RSVP | Unknown Information | |
| Content ID | Items in RSVP Content | UIIE |
| R3 | 10 | 0.70 |
| R4 | 9 | 0.69 |
| R5 | 4 | 0.75 |
| R7 | 2 | 0.50 |

Also in step 606, the Unknown Information Items Exclusivity Normalized (UIIEₙₒᵣₘ) is computed for each qualified RSVP content item in the object list. Normalized rating value is computed by dividing the UIIE value of each RSVP content item by the maximum UIIE value of all qualified RSVP contents in the object list, as shown in the formula below:

$${UIIE}_{norm} = UIIE \times \frac{1}{{UIIE}_{max}}$$

In the above formula, the UIIEₙₒᵣₘ of the most exclusive RSVP content item in the object list obtains the value of 1. All other UIIEₙₒᵣₘ values in the object list are between 0 and 1.

Table 15 shows the UIIEₙₒᵣₘ values for the example data generated from Table 14 in step 606 for each unknown information item in the qualified RSVP content items in the object list.

TABLE 15
Unknown Information Item Exclusivity Normalized Example

| RSVP | | |
|---|---|---|
| Content ID | UIIE | UIIEₙₒᵣₘ |
| R3 | 0.70 | 0.93 |
| R4 | 0.69 | 0.92 |
| R5 | 0.75 | 1 |
| R7 | 0.50 | 0.67 |

After the relevance rating values have been computed for all RSVP content items in the object list, step 606 proceeds to compute the Ranking Value (“RV”). The RV integrates the relevance ratings into one value that can be used to rank and order the RSVP contents in the object list from most relevant (highest RV) to least relevant (lowest RV) to the user, as shown in the formula below:

$$RV = \frac{{w}_{1} * NIR + {w}_{2} * {UIID}_{norm} + {w}_{3} * {UIIE}_{norm} + {w}_{4} * UIF}{4}$$

In the formula above, for each rating value, a different weighting factor “w” may be utilized. These weighting factors enable adjustment of RV for specific needs. One rating value can be weighted higher or lower than others, resulting in an emphasis on that type of relevance. In the example in Table 16 below, the values of RV have been computed using three different weightings: equally weighted (all “w” values set to 1), focused on NIR (w₁ set to a value of 5 while all other “w” values set to 1), and focused on UIIDₙₒᵣₘ (w₂ set to a value of 5 while all other “w” values set to 1).

TABLE 16
Ranking values

| RSVP | | | | | Ranking value | Ranking value | Ranking value |
|---|---|---|---|---|---|---|---|
| Content | | | | | (equally | (focused on | (focused on |
| ID | NIR | UIIDₙₒᵣₘ | UIIEₙₒᵣₘ | UIF | weighted) | NIR) | UIIDₙₒᵣₘ) |
| R3 | 1 | 1 | 0.93 | 0.46 | 0.85 | 0.92 | 0.92 |
| R4 | 0.82 | 0.97 | 0.92 | 0.50 | 0.80 | 0.81 | 0.89 |
| R5 | 1 | 0.50 | 1 | 0.46 | 0.74 | 0.87 | 0.62 |
| R6 | 0 | 0 | 0 | 0 | 0 | 0 | 0 |
| R7 | 1 | 0.92 | 0.67 | 0.69 | 0.82 | 0.91 | 0.87 |

After the ranking of all RSVP content items in the object list is completed in step 606, step 607 presents the adjusted object list to the user. The adjusted object list may be returned entirely, or in segments.

Table 17 shows the results of adjusting the object list of the example from Table 5 with the ranking values from Table 16 according to step 606.

TABLE 17
Object List Example

| | RSVP | | Original | Adjusted Object | Adjusted Object | Adjusted Object |
|---|---|---|---|---|---|---|
| User | Content | Topic | Object | Rank (equally | Rank (focused on | Rank (focused on |
| ID | ID | ID | Rank | weighted) | NIR) | UIIDₙₒᵣₘ) |
| U1 | R3 | T1 | 1 | 1 | 1 | 1 |
| U1 | R4 | T1 | 2 | 3 | 4 | 2 |
| U1 | R5 | T1 | 3 | 4 | 3 | 4 |
| U1 | R6 | T1 | 4 | 5 | 5 | 5 |
| U1 | R7 | T1 | 5 | 2 | 2 | 3 |

In some embodiments, the user may be able to select the weightings of each RV factor to be applied to the object list as a user preference in the search application on the user device. Alternatively, the user may be able to select a setting which ranks only RSVP content items in user information table 618 in DB 113 only which have been consumed by the user. In such a use case, the user may be trying to find content items that he has previously consumed.

The data in RSVP DB 113 is built from actual user attention related data (reading of RSVP content) collected from RSVP applications that can be distributed to users in all parts of the world. Thus, the RSVP trending and tracking data stored in DB 113 contains useful information that can be used to adjust an initial object ranking and produce more relevant and interesting results for a user.

Initial content ranking, or initial page ranking, may be based, for example, on simple keyword frequency and the order in which search terms appear in an object (or other factors such as click count or links), to influence the initial page ranking RSVP data may be used in conjunction with initial rank data to rank search results, or object lists.

The tracking and trending data in the RSVP database (i.e., DB 113) is continually being enhanced to support search engines and RSVP search ranking applications implementing method 4500, or any applications or programs that may rely on RSVP DB 113 or RSVP tracking and trending data.

Accordingly, using this data in a content-ranking algorithm (e.g., RSVP search ranking application implementing method 600 or other ranking algorithm) is an improvement over previous approaches in that it relies at least in part on more direct evidence of content consumption of individual users in the form of words displayed to users via RSVP. The fields, variables and tables described above are used as examples for clarity of explanation of the RSVP search result enrichment process and are not limited thereto.

The embodiment illustrated in FIG. 6 is particularly suited to implementations in which steps 602-606 are implemented on a server computer and then the result (i.e., an object list that has been ranked using known information metrics) is sent to the user device for presenting to the user in step 607. However, it is possible to modify the embodiment of FIG. 6 to accommodate enhanced user privacy so that metrics related to known user information data are computed and used only on the user's electronic device. For example, all the raw results of an initial search query can be analyzed first on a server to identify information items. Then, an initial object list including identifiers for each candidate content item on the object list along with data identifying information items for the candidate content items can be sent to the user electronic device. In such an implementation, steps 603-607 of a modified version of the process shown in FIG. 6 could be performed entirely on the user's device to provide a modified object list to the user that reflects analysis of the relationship between information items known to the user (based on RSVP tracking data) and information items in search results (i.e., the candidate content items) represented on the object list. Once the user makes a selection, the content of the selected search result can be delivered to the user. In this manner, RSVP tracking data and computed metrics regarding the degree to which information items are “new” versus “known” can be used to enhance the search results without ever having RSVP tracking data for that user or the computed metrics described above sent to a server computer. For example, in such an alternative embodiment, the portions of DB 113 that are specific to a viewing user, for example, all data related to that user's User ID in user information table 618 and all the computed rating values related to that user's User ID in rating values table 621, can be maintained exclusively on that user's device.

Referring more generally to the process illustrated in FIG. 6, the same principles regarding use of information item metrics discussed in the context of a typical search application apply to the context of providing sponsored content to a user. For example, if a user clicks on a sponsored content representation, that content selection can be used through known methods to identify potential candidate advertisements to present to the user. The provider may then use the relevance rating metrics described above to select, for initial presentation to the user, those candidate advertisements that are unknown to the user and that the user may need to consume in order to reach a decision, such as making a purchase transaction. In other words, an object list representing a set of potential advertisements that are identified based on a user interface action (e.g., clicking on particular content) are functionally the same for purposes of the described embodiment as an object list representing a set of search results obtained in response to user entry of search terms. The potential advertisements referenced on an object list can be analyzed for information items and, using data regarding information items that have been viewed by the user, metrics determining the degree to which particular ads contain unknown information items can be used to select a particular ad or to rank the object list for presenting selectable ad titles to the user in an order of relevance (e.g., listing ads with the most unknown information items first).

The same principles can also apply in the context of providing electronic news articles to a user. For example, metrics regarding the relationship between a user's likely known information items (based on RSVP consumption data) and the information items in available news articles can be computed and used by an information portal provider to present news articles containing information items that the user has not yet consumed. The user is likely to be more interested in reading unknown information items about a topic. At the same time, the topic itself might be selected by the user based on user-interface actions and/or the user's profile provided to the information portal. In terms of applying the principles of an embodiment of the present invention, there is not necessarily a conceptual difference between ranking and/or narrowing a list of potential news articles within a topic area using metrics regarding information items in the user versus information items known to the user and doing the same task with respect to a list of search results as described in detail above with respect to FIG. 6.

### ADDITIONAL EMBODIMENTS

Method(s), computer program product(s), and/or system(s) for tracking digital content consumption by a user of one or more electronic devices, by at least: providing, during one or more user sessions associated with the user, digital content, including textual content, to one or more electronic devices of the user, the one or more electronic devices being enabled to display words of the digital content using rapid serial visual presentation (RSVP); determining whether any sets of one or more words in the textual content have been designated as information items and, if not, then using a natural language processing (NLP) algorithm to identify and designate sets of one or more words in the textual content as information items; and tracking display by RSVP of designated information items on the one or more electronic devices to generate first data, the first data indicating the identity of information items displayed on the one or more electronic device across the one or more user sessions associated with the user and the number of times each information item was displayed during the one or more user sessions and when.

The embodiment of paragraph [00126] further comprising: receiving an object list representing candidate content items in response to a user interaction on an electronic device; determining what sets of one or more words in the candidate content items have been designated as information items; computing a metric corresponding to a strength in overlap between the first data and the information items in the candidate content items; and using the computed metric to affect a ranking of the candidate content items for presentation to the user.

The embodiment of paragraph [00127] wherein computing the metric comprises determining, for each candidate content item, how many information items in the candidate content item correspond to information items in the first data.

The embodiment of paragraph [00128] wherein using the computed metric comprises ranking a first candidate item higher than a second candidate content item if the first candidate content item has fewer information items corresponding to information items in the first data than the second result has.

The embodiment of paragraph [00126] wherein: at least some designated information items are associated with an equivalent information item designation allowing two or more information items to be designated as equivalent even if words in the two or more designated information items are not identical; and tracking comprises using equivalent item designations to generate the first data such that the first data indicates the number of times that information items corresponding to the same equivalent information item designation are displayed by RSVP on the user electronic device.

The embodiment of paragraph [00127] wherein: tracking comprises tracking, for each display of an information item using RSVP, the date on which the display occurred; and computing the metric comprises weighting display of information items based on how recently the items were displayed to the user wherein the metric indicates a stronger overlap between the first data and the identity and quantity of information items in a candidate content item for information items that have been displayed more recently by RSVP to the user than for information items that have been displayed less recently by RSVP to the user.

The embodiment of paragraph [00126] wherein the first data is stored on an electronic device of the user without being transmitted to a server computer.

The embodiment of paragraph [00127] wherein the first data is stored on an electronic device of the user without being transmitted to a server computer and wherein computing the metric and using the computed metric is performed on the electronic device of the user.

The embodiment of paragraph [00127] wherein the candidate content items are search results and the user interaction is entry of a search query.

The embodiment of paragraph [00127] wherein the candidate content items are electronic advertisements and the user interaction is an interface action indicating selection of a content item.

The embodiment of paragraph [00127] wherein the candidate content items are news articles and the user interaction is an interface action selecting a topic, the news articles being associated with the topic.

The embodiment of paragraph [00127] wherein the candidate content items are news articles and the user interaction is an interface action selecting a content item.

The embodiment of paragraph [00127] wherein the candidate content items are news articles and the user interaction is an interface action initiating a news portal application.

The embodiment of paragraph [00138] wherein data in a user profile is used to identify the candidate content items.

While the present invention has been particularly described with respect to the illustrated embodiments, it will be appreciated that various alterations, modifications and adaptations may be made based on the present disclosure, and are intended to be within the scope of the present invention. While the invention has been described in connection with what are presently considered to be the most practical and preferred embodiments, it is to be understood that the present invention is not limited to the disclosed embodiments but, on the contrary, is intended to cover various modifications and equivalent arrangements included within the scope of the appended claims.

1. A computer-implemented method for tracking digital content consumption by a user of one or more electronic devices, each step of the method being accomplished using one or more computers, wherein during one or more user sessions associated with the user, digital content, including textual content, is provided to an electronic device of the one or more electronic devices, the one or more electronic devices being configured to display textual content of the digital content using rapid serial visual presentation (RSVP), the method comprising:
determining whether any sets of one or more words in the textual content have been designated as information items and, if not, then using a natural language processing (NLP) algorithm to identify and designate sets of one or more words in the textual content as information items; and
tracking display by RSVP of textual content designated as information items on the one or more electronic devices to generate first data, the first data indicating an identity of information items displayed on the one or more electronic devices across the one or more user sessions and a number of times each information item was displayed during the one or more user sessions.

2. The method of claim 1 further comprising:
receiving, at a server computer, an object list representing candidate content items in response to a user interaction on an electronic device;
determining what sets of one or more words in the candidate content items have been designated as information items;
computing a metric corresponding to a strength in overlap between the first data and the information items in the candidate content items; and
using the computed metric to affect a ranking of the candidate content items for presentation to the user.

3. The method of claim 2 wherein computing the metric comprises determining, for each candidate content item, how many information items in the candidate content item correspond to information items in the first data.

4. The method of claim 3 wherein using the computed metric comprises ranking a first candidate content item higher than a second candidate content item if the first candidate content item has fewer information items corresponding to information items in the first data than the second candidate content item.

5. The method of claim 1 wherein:
at least some designated information items are associated with an equivalent information item designation allowing two or more information items to be designated as equivalent even if words in the two or more designated information items are not identical; and
tracking display comprises using equivalent information item designations to generate the first data such that the first data indicates the number of times that information items corresponding to the same equivalent information item designation are displayed by RSVP on any electronic device of the one or more electronic devices during a session associated with the user.

6. The method of claim 2 wherein:
tracking display comprises tracking, for each display of an information item using RSVP, when the display occurred; and
computing the metric comprises weighting display of information items based on how recently the information items were displayed during the one or more user sessions, wherein the metric indicates a stronger overlap between the first data and identities and quantities of information items in a candidate content item for information items that have been displayed more recently by RSVP during the one or more user sessions than for information items that have been displayed less recently by RSVP during the one or more user sessions.

7. The method of claim 1 wherein the first data is stored on an electronic device of the one or more electronic devices without being transmitted to a server computer.

8. The method of claim 2 wherein the first data is stored on an electronic device of the one or more electronic devices without being transmitted to a server computer and wherein computing the metric and using the computed metric is performed on the electronic device.

9. The method of claim 2 wherein the candidate content items are search results and the user interaction is an entry of a search query.

10. The method of claim 2 wherein the candidate content items are electronic advertisements and the user interaction is an interface action indicating selection of a content item.

11. The method of claim 2 wherein the candidate content items are news articles and the user interaction is an interface action selecting a topic, the news articles being associated with the topic.

12. The method of claim 2 wherein the candidate content items are news articles and the user interaction is an interface action selecting a content item.

13. The method of claim 2 wherein the candidate content items are news articles and the user interaction is an interface action initiating a news portal application.

14. The method of claim 2 wherein data in a user profile is used to identify the candidate content items.

15. A computer system for tracking digital content consumption by a user of one or more electronic devices, wherein during one or more user sessions associated with the user, digital content, including textual content, is provided to an electronic device of the one or more electronic devices, the one or more electronic devices being configured to display textual content of the digital content using rapid serial visual presentation (RSVP), the computer system comprising one or more computers configured to:
determine whether any sets of one or more words in the textual content have been designated as information items and, if not, then using a natural language processing (NLP) algorithm to identify and designate sets of one or more words in the textual content as information items; and
track display by RSVP of textual content designated as information items on the one or more electronic devices to generate first data, the first data indicating an identity of information items displayed on the one or more electronic devices across the one or more user sessions and a number of times each information item was displayed during the one or more user sessions.

16. The system of claim 15, wherein the one or more computers are further configured to:
receive an object list representing candidate content items in response to a user interaction on an electronic device;
determine what sets of one or more words in the candidate content items have been designated as information items;
compute a metric corresponding to a strength in overlap between the first data and the information items in the candidate content items; and
use the computed metric to affect a ranking of the candidate content items for presentation to the user.

17. The system of claim 16 wherein computing the metric comprises determining, for each candidate content item, how many information items in the candidate content item correspond to information items in the first data.

18. The system of claim 17 wherein using the computed metric comprises ranking a first candidate content item higher than a second candidate content item if the first candidate content item has fewer information items corresponding to information items in the first data than the second candidate content item.

19. The system of claim 15 wherein:
at least some designated information items are associated with an equivalent information item designation allowing two or more information items to be designated as equivalent even if words in the two or more designated information items are not identical; and
tracking display comprises using equivalent information item designations to generate the first data such that the first data indicates the number of times that information items corresponding to the same equivalent information item designation are displayed by RSVP on any electronic device of the one or more electronic devices during a session associated with the user.

20. The system of claim 16 wherein:
tracking display comprises tracking, for each display of an information item using RSVP, when the display occurred; and
computing the metric comprises weighting display of information items based on how recently the information items were displayed during the one or more user sessions, wherein the metric indicates a stronger overlap between the first data and identities and quantities of information items in a candidate content item for information items that have been displayed more recently by RSVP during the one or more user sessions than for information items that have been displayed less recently by RSVP during the one or more user sessions.

21. The system of claim 16 wherein the candidate content items are search results and the user interaction is an entry of a search query.

22. The system of claim 16 wherein the candidate content items are electronic advertisements and the user interaction is an interface action indicating selection of a content item.

23. The system of claim 16 wherein the candidate content items are news articles and the user interaction is an interface action selecting a topic, the news articles being associated with the topic.

24. The system of claim 16 wherein the candidate content items are news articles and the user interaction is an interface action selecting a content item.

25. The system of claim 16 wherein the candidate content items are news articles and the user interaction is an interface action initiating a news portal application.

26. The system of claim 16 wherein data in a user profile is used to identify the candidate content items.

27. A computer program product embedded in a non-transitory computer readable medium including instructions executable by a computer processor for tracking digital content consumption, wherein during one or more user sessions associated with the user, digital content, including textual content, is provided to an electronic device of the one or more electronic devices, the one or more electronic devices being configured to display textual content of the digital content using rapid serial visual presentation (RSVP), the instructions being executable by a computer processor to:
determine whether any sets of one or more words in the textual content have been designated as information items and, if not, then using a natural language processing (NLP) algorithm to identify and designate sets of one or more words in the textual content as information items; and
track display by RSVP of textual content designated as information items on the one or more electronic devices to generate first data, the first data indicating an identity of information items displayed on the one or more electronic devices across the one or more user sessions and a number of times each information item was displayed during the one or more user sessions.

28. The computer program product of claim 27, further comprising instructions executable by the computer processor to:
receive an object list representing candidate content items in response to a user interaction on an electronic device;
determine what sets of one or more words in the candidate content items have been designated as information items;
compute a metric corresponding to a strength in overlap between the first data and the information items in the candidate content items; and
use the computed metric to affect a ranking of the candidate content items for presentation to the user.

29. The computer program product of claim 28 wherein computing the metric comprises determining, for each candidate content item, how many information items in the candidate content item correspond to information items in the first data.

30. The computer program product of claim 29 wherein using the computed metric comprises ranking a first candidate content item higher than a second candidate content item if the first candidate content item has fewer information items corresponding to information items in the first data than the second candidate content item.

31. The computer program product of claim 27 wherein:
at least some designated information items are associated with an equivalent information item designation allowing two or more information items to be designated as equivalent even if words in the two or more designated information items are not identical; and
tracking display comprises using equivalent information item designations to generate the first data such that the first data indicates the number of times that information items corresponding to the same equivalent information item designation are displayed by RSVP on any electronic device of the one or more electronic devices during a session associated with the user.

32. The computer program product of claim 28 wherein:
tracking display comprises tracking, for each display of an information item using RSVP, when the display occurred; and
computing the metric comprises weighting display of information items based on how recently the information items were displayed during the one or more user sessions, wherein the metric indicates a stronger overlap between the first data and identities and quantities of information items in a candidate content item for information items that have been displayed more recently by RSVP during the one or more user sessions than for information items that have been displayed less recently by RSVP during the one or more user sessions.

33. The computer program product of claim 27 wherein the first data is stored on an electronic device of the one or more electronic devices without being transmitted to a server computer.

34. The computer program product of claim 28 wherein the first data is stored on an electronic device of the one or more electronic devices without being transmitted to a server computer and wherein computing the metric and using the computed metric is performed on the electronic device.

35. The computer program product of claim 28 wherein the candidate content items are search results and the user interaction is an entry of a search query.

36. The computer program product of claim 28 wherein the candidate content items are electronic advertisements and the user interaction is an interface action indicating selection of a content item.

37. The computer program product of claim 28 wherein the candidate content items are news articles and the user interaction is an interface action selecting a topic, the news articles being associated with the topic.

38. The computer program product of claim 28 wherein the candidate content items are news articles and the user interaction is an interface action selecting a content item.

39. The computer program product of claim 28 wherein the candidate content items are news articles and the user interaction is an interface action initiating a news portal application.

40. The computer program product of claim 28 wherein data in a user profile is used to identify the candidate content items.

41. A computer-implemented method for ranking candidate content items for presentation to a user of one or more electronic devices, each step of the method being accomplished using one or more computers, wherein during one or more user sessions associated with the user, digital content, including textual content, is provided to an electronic device of the one or more electronic devices, the one or more electronic devices being configured to display textual content of the digital content using rapid serial visual presentation (RSVP), and wherein display by RSVP of textual content designated as information items on the one or more electronic devices is tracked to generate first data, the first data indicating an identity of information items displayed on the one or more electronic devices across the one or more user sessions and a number of times each information item was displayed during the one or more user sessions, the method comprising:
receiving, at a server computer, an object list representing candidate content items in response to a user interaction on an electronic device;
determining what sets of one or more words in the candidate content items have been designated as information items;
computing a metric corresponding to a strength in overlap between the first data and the information items in the candidate content items; and
using the computed metric to affect a ranking of the candidate content items for presentation to the user.

42. The method of claim 41 wherein using the metric comprises ranking a first candidate item higher than a second candidate item if the first candidate item has fewer designated information items that match information items in the first data that the second candidate content item has.
